(19) United States
(12) Patent Application Publication
(10) Pub. No.: US 2018/0234163 A1
(43) Pub. Date: Aug. 16, 2018

(54) RELAY DEVICE AND RELAY METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Yongbo Zeng, Beijing (CN); Yongsheng Zhang, Beijing (CN)

(73) Assignee: NTT DOCOMO, INC., Tokyo (JP)

(21) Appl. No.: 15/750,129

(22) PCT Filed: Aug. 12, 2016
(86) PCT No.: PCT/JP2016/073738

§ 371 Date: Feb. 2, 2018

(30) Foreign Application Priority Data
Aug. 13, 2015 (JP) 2015-160001

(51) Int. Cl. H04B 7/155; H04W 72/04; H04W 92/18; H04W 16/26

(52) U.S. Cl. CPC H04B 7/15592; H04W 72/0406; H04W 76/14; H04W 16/26; H04W 92/18

(57) ABSTRACT

A relay device of a mobile communication system supporting Device to Device (D2D) communication that includes a transmitter that transmits, on a second carrier, a broadcast message indicating that a relay process can be executed, the relay process being such that a message to be received on a first carrier is to be transmitted on the second carrier; and a relay unit that transmits, on the second carrier, the message received on the first carrier.

### TECHNICAL FIELD

The present invention relates to a technique for transmission and reception of D2D signals in a mobile communication system supporting D2D.

### BACKGROUND ART

In LTE (Long Term Evolution) and the successor system of LTE (which is also referred to, for example, as LTE-A (LTE Advanced), FRA (Future Radio Access), 4G, and so forth), D2D (Device to Device) technology has been studied (e.g., Non-Patent Document 1) such that units of user equipment directly communicate with each other without going through a radio base station.

D2D allows traffic between the user equipment and the base station to be reduced, and allows communication between units of user equipment to be performed even if the base station becomes unable to communicate at the time of disaster.

D2D is roughly classified into D2D discovery (D2D discovery, which is also referred to as D2D detection) and D2D communication (D2D direct communication). In the following, when D2D communication, D2D discovery, etc., are not particularly distinguished, they are simply referred to as D2D. Furthermore, signals transmitted and received in D2D are referred to as D2D signals.

Also, in 3GPP (3rd Generation Partnership Project), it is being studied to realize V2V by extending D2D functions. As illustrated in FIG. 1, V2X includes V2V (Vehicle to Vehicle) that means a communication mode performed between an automobile and an automobile; V2I (Vehicle to Infrastructure) that means a communication mode performed between an automobile and a road-side unit (RSU: Road-Side Unit) that is to be installed at a road side; V2N (Vehicle to Nomadic device) that means a communication mode performed between an automobile and a mobile terminal of a driver; V2P (Vehicle to Pedestrian) that means a communication mode performed between an automobile and a mobile terminal of a pedestrian, and so forth.

### PRIOR ART DOCUMENT

### Non-Patent Document

Non-Patent Document 1: “Key drivers for LTE success: Services Evolution,” September 2011, 3GPP, Internet URL: http://www.3gpp.org/ftp/Information/presentations/presentations_2011/2011_09_LTE_Asia/2011_LTE-Asia_3GPP_Service_evolution.pdf
Non-Patent Document 2: 3GPP TS 36.213 V12.4.0 (2014-12)

### SUMMARY OF INVENTION

### Problem to be Solved by the Invention

In V2X, it is assumed that communication is to be performed among a large number of UEs. Thus, in order to expand the capacity of V2X and to avoid interference between V2X and general D2D, it can be considered to use different carriers between V2X and general D2D.

For example, as illustrated in FIG. 2, the UE 1 performs D2D signal transmission and reception with the UE 2 using a D2D carrier, while performing V2X signal transmission and reception with the UE 3 using a V2X carrier. Note that FIG. 2 shows a D2D resource pool and resources for UL transmission to the base station (eNB), among resources of the D2D carrier.

Furthermore, as illustrated in FIG. 3, it can be considered to use a plurality of carriers in V2X. For example, it can be considered to use different carriers for respective operators (PLMNs). In order to implement D2D/V2X communication in an environment where the plurality of carriers are used, as illustrated in FIGS. 2 and 3, each UE is configured to include, for example, a single radio device (Tx/Rx chain) to switch carriers (frequencies); or is configured to include a plurality of radio devices for respective carriers. However, if the plurality of radio devices are to be included, the cost increases. Furthermore, if the plurality of carriers are to be switched by the single radio device, a problem is that it takes time to switch them, and that time resources are unnecessarily consumed. Namely, the problem is that transmission and reception of V2X/D2D signals may not be properly performed among a plurality of carriers.

Note that, if it is considered that V2X is a type of D2D, the above-described problem is not limited to V2X, and may occur in D2D in general.

The present invention has been achieved in view of the above-described point, and an object is to provide, in a mobile communication system supporting D2D, a technique for allowing D2D signals to be properly transmitted and received among a plurality of carriers.

### Means for Solving the Problem

According to an embodiment of the present invention, there is provided a relay device of a mobile communication system supporting D2D, the relay device including a transmitter that transmits, on a second carrier, a broadcast message indicating that a relay process can be executed, the relay process being such that a message to be received on a first carrier is to be transmitted on the second carrier; and a relay unit that transmits, on the second carrier, the message received on the first carrier.

Furthermore, according to the embodiment of the present invention, there is provided a relay device of a mobile communication system supporting D2D, the relay device including a transmitter that transmits, on a second carrier, a broadcast message indicating that a relay process can be executed, the relay process being such that a message to be received on a first carrier is to be transmitted on the second carrier; a receiver that receives a relay request for requesting to transmit, on the second carrier, the message to a specific destination by the relay process; and a relay unit that transmits, upon receiving, on the first carrier, the message specifying the specific destination, the message to the specific destination on the second carrier, based on the relay request.

Furthermore, according to the embodiment of the present invention, there is provided a relay method to be executed by a relay device of a mobile communication system supporting D2D, the relay method including a transmission step of transmitting, on a second carrier, a broadcast message indicating that a relay process can be executed, the relay process being such that a message to be received on a first carrier is to be transmitted on the second carrier; and a relay step of transmitting, on the second carrier, the message received on the first carrier.

Furthermore, according to the embodiment of the present invention, there is provided a relay method to be executed by a relay device of a mobile communication system supporting D2D, the relay method including a transmission step of transmitting, on a second carrier, a broadcast message indicating that a relay process can be executed, the relay process being such that a message to be received on a first carrier is to be transmitted on the second carrier; a reception step of receiving a relay request for requesting to transmit, on the second carrier, the message to a specific destination by the relay process; and a relay step of transmitting, upon receiving, on the first carrier, the message specifying the specific destination, the message to the specific destination on the second carrier, based on the relay request.

### Advantage of the Invention

According to the embodiment of the present invention, a technique is provided, which is for allowing D2D signals to be properly transmitted and received among a plurality of carriers in a mobile communication system supporting D2D.

### BRIEF DESCRIPTION OF DRAWINGS

FIG. 1 is a diagram for illustrating V2X;

FIG. 2 is a diagram for illustrating carriers of D2D and V2X;

FIG. 3 is a diagram illustrating a problem;

FIG. 4A is a diagram for illustrating D2D;

FIG. 4B is a diagram for illustrating D2D;

FIG. 5 is a diagram for illustrating an example of a channel structure used in D2D;

FIG. 6A is a diagram illustrating an example of a structure of a PSDCH;

FIG. 6B is a diagram illustrating an example of the structure of the PSDCH;

FIG. 7A is a diagram illustrating examples of structures of a PSCCH and a PSSCH;

FIG. 7B is a diagram illustrating example of the structures of the PSCCH and the PSSCH;

FIG. 8A is a diagram illustrating a resource pool configuration;

FIG. 8B is a diagram illustrating a resource pool configuration;

FIG. 9A is a diagram illustrating an example a structure of PSSS/SSSS;

FIG. 9B is a diagram illustrating an example of the structure of the PSSS/SSSS;

FIG. 10 is a configuration diagram of a communication system according to an embodiment of the present invention;

FIG. 11A is a diagram illustrating an outline of a first embodiment;

FIG. 11B is a diagram illustrating the outline of the first embodiment;

FIG. 12 is a diagram illustrating an outline of a second embodiment;

FIG. 13 is a diagram for illustrating an operation example 1-1;

FIG. 14 is a diagram for illustrating an operation example 1-2;

FIG. 15 is a diagram for illustrating an operation example 1-3;

FIG. 16 is a diagram illustrating a sequence example 1 for specifying a L2 address;

FIG. 17 is a diagram illustrating a sequence example 2 for specifying the L2 address;

FIG. 18 is a diagram illustrating a sequence example for a transmission source address;

FIG. 19 is a diagram illustrating an example of a MAC subheader;

FIG. 20 is a diagram illustrating a configuration that is an assumption of an operation example in the second embodiment;

FIG. 21 is a sequence diagram illustrating an operation example 2-1;

FIG. 22 is a sequence diagram illustrating an operation example 2-2;

FIG. 23 is a diagram for illustrating an operation for relaying data;

FIG. 24 is a diagram for illustrating a modified example 1;

FIG. 25 is a flowchart illustrating an operation of a relay device in the modified example 1;

FIG. 26 is a diagram for illustrating a modified example 2;

FIG. 27 is a diagram for illustrating a modified example 3;

FIG. 28 is a sequence diagram for illustrating the modified example 3;

FIG. 29 is a diagram illustrating an example of a MAC subheader when hop number counting is to be performed;

FIG. 30A is a diagram illustrating an example of control from an eNB;

FIG. 30B is a diagram illustrating the example of the control from the eNB;

FIG. 31A is a diagram illustrating an example of a resource pool for relaying;

FIG. 31B is a diagram illustrating the example of the resource pool for relaying;

FIG. 32 is a diagram illustrating an example of a resource configuration;

FIG. 33 is a configuration diagram of a relay device (RELAY);

FIG. 34 is a configuration diagram of user equipment (UE);

FIG. 35 is a configuration diagram of a base station (eNB); and

FIG. 36 is a HW configuration diagram of each of the Relay, UE, and eNB.

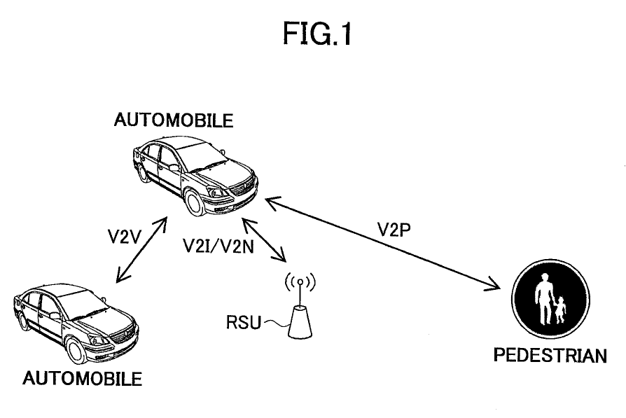

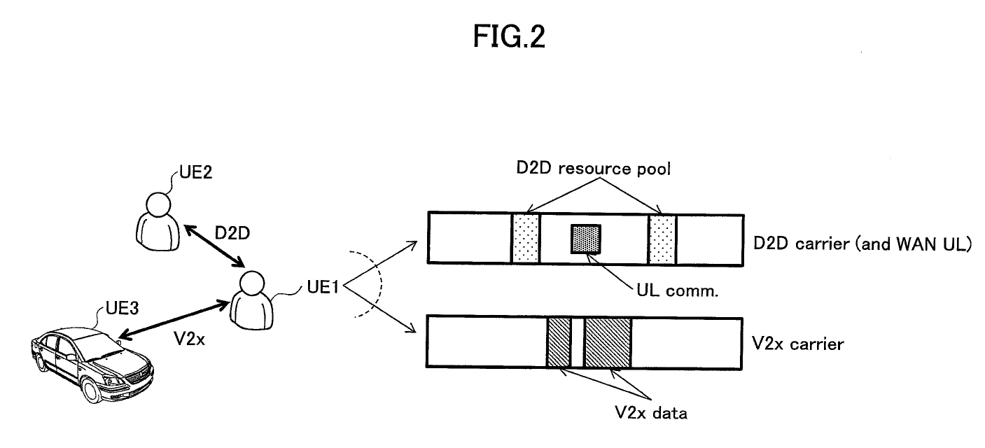

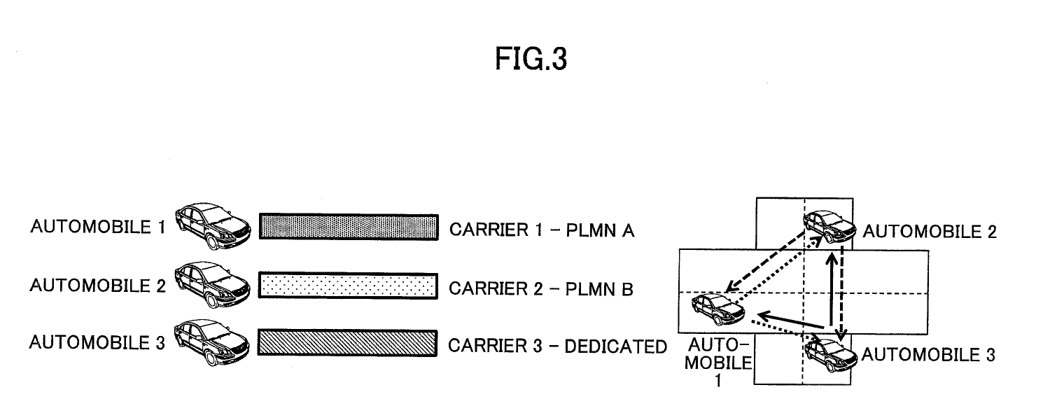

### EMBODIMENTS OF THE INVENTION

In the following, embodiments of the present invention are described by referring to the figures. The embodiments illustrated below are merely examples; and embodiments to which the present invention is applied are not limited to the following embodiments. For example, it is assumed that a mobile communication system according to the embodiment is a system based on a scheme conforming to LTE; however, the present invention is not limited to LTE, and is applicable to another scheme. Furthermore, in the present invention and in the scope of the claims, “LTE” is used in a broad sense that can include a communication scheme corresponding to Rel-12, 13, or on or after that of 3GPP (including 5G).

Furthermore, in the embodiment, V2X and D2D are described so that they are distinguished. This may be considered that D2D using a certain carrier is referred to as “V2X,” among a plurality of D2Ds using different carriers. Since V2X is a type of D2D, “V2X” described below may be replaced with “D2D.” The technique according to the present invention is applicable to D2D in general including V2X.

Furthermore, in the embodiment, relaying between different carriers is described; however, even if it is between the same carriers, relaying can be performed similar to relaying between the different carriers.

In the following, basically, the relay device is denoted as “RELAY,” the base station is denoted as “eNB,” and the user equipment is denoted as “UE.” The eNB is an abbreviation for “evolved Node B,” and the UE is an abbreviation for “User Equipment.”

(Outline of D2D)

The technology of V2X according to the embodiment is based on the technology of D2D specified in LTE, so that an outline of D2D specified in LTE is described first.

In D2D specified in LTE, each UE executes transmission and reception of signals using a part of uplink resources which have already been specified as resources for uplink signal transmission from the UE to the eNB.

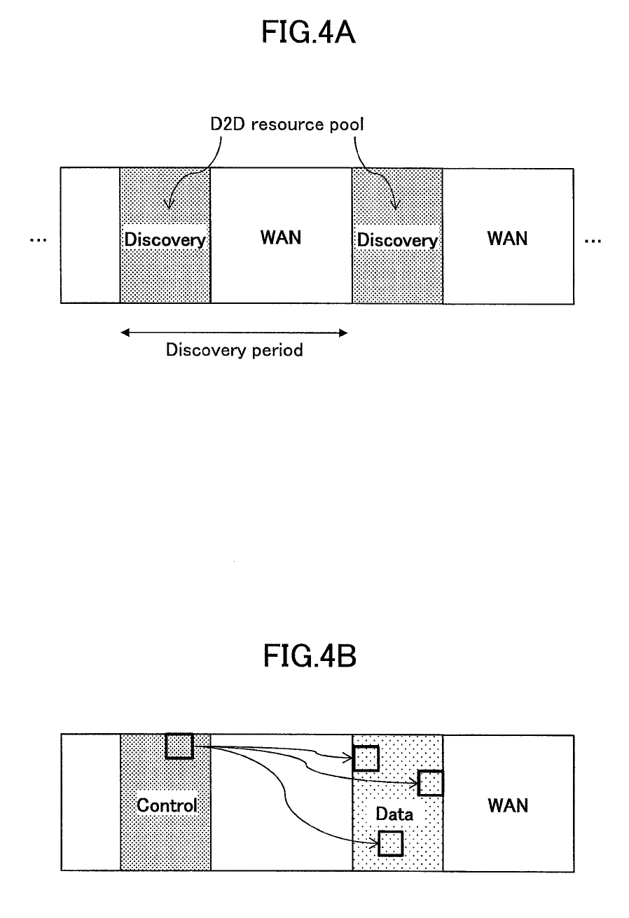

As for “Discovery”, a resource for a Discovery message is reserved for each Discovery period, as illustrated in FIG. 4A; and the UE transmits a Discovery message in the resource pool. More specifically there are Type 1 and Type 2b. In Type 1, the UE autonomously selects a transmission resource from a resource pool. In Type 2b, semi-static resources are allocated by higher layer signaling (e.g., a RRC signal).

For “Communication,” a resource pool for Control/Data transmission is periodically reserved, as illustrated in FIG. 4B. The transmitting UE reports a resource for Data transmission, etc., to a receiving side by SCI (Sidelink Control Information) with a resource selected from a Control resource pool (SCI resource pool); and transmits Data with the resource for Data transmission. More specifically, for “Communication,” there are Mode 1 and Mode 2. In Mode 1, resources are dynamically allocated by a (E)PDCCH transmitted from an eNB to UE. In Mode 2, UE autonomously selects a transmission resource from the resource pool for Control/Data transmission. As for the resource pool, one that is reported by a SIB or a predetermined one is to be used.

In LTE, a channel used for “Discovery” is called a PSDCH (Physical Sidelink Discovery Channel); a channel for transmitting control information in “Communication,” such as SCI, is called a PSCCH (Physical Sidelink Control Channel); and a channel for transmitting data is called a PSSCH (Physical Sidelink Shared Channel) (Non-Patent Document 2).

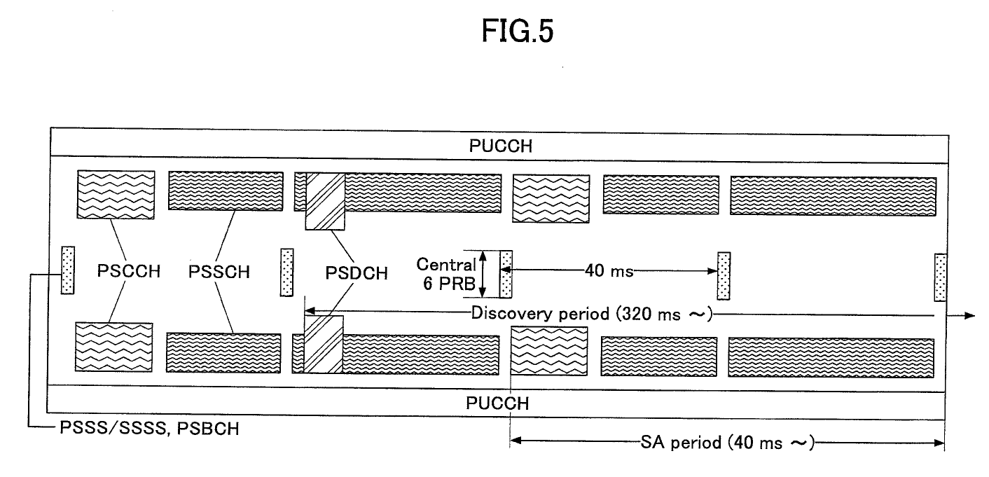

An example of a channel structure of D2D is shown in FIG. 5. As shown in FIG. 5, a PSCCH resource pool and a PSSCH resource pool used for Communication are allocated. Furthermore, a PSDCH resource pool used for Discovery is allocated with a period that is longer than a period of the channel of Communication.

Furthermore, PSSS (Primary Sidelink Synchronization) and SSSS (Secondary Sidelink Synchronization) are used as synchronization signals for D2D. Furthermore, for example, a PSBCH (Physical Sidelink Broadcast Channel) for transmitting broadcast information (broadcast information), such as a system band for D2D, a frame number, and resource configuration information, is used for outside coverage operation.

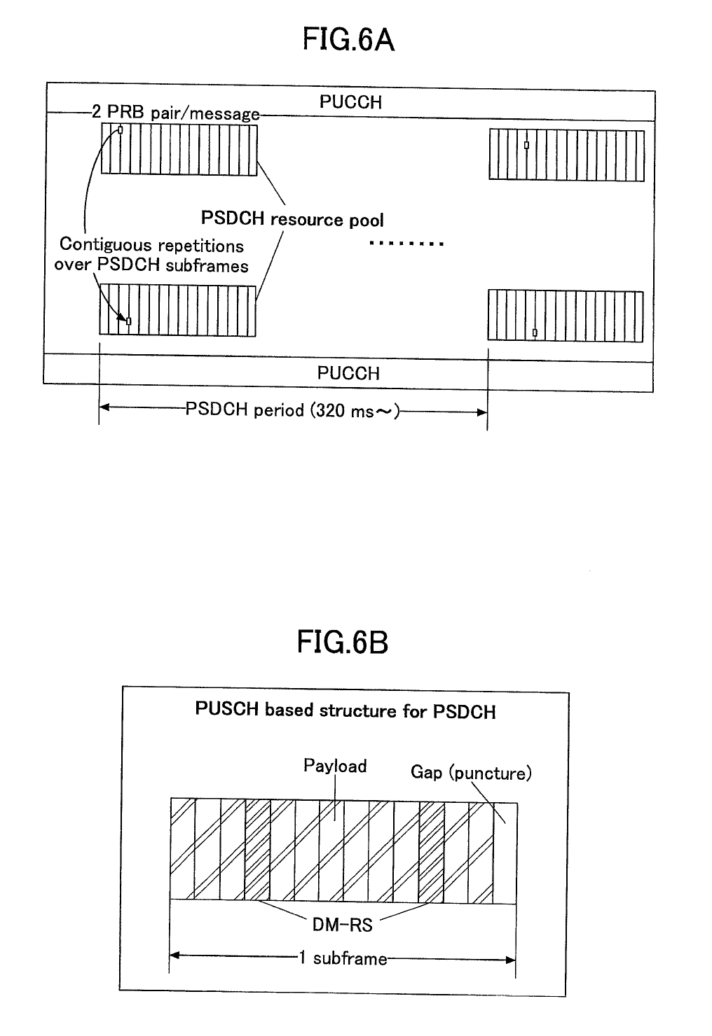

FIG. 6A shows an example of a PDSCH resource pool used for Discovery. Since a resource pool is configured by a bitmap of subframes, the resource pool becomes such that its image is as shown in FIG. 6A. The resource pools for other channels are the same. Furthermore, the PSDCH is repeatedly transmitted (repetition) while being frequency-hopped. The number of times of repetitions can be configured to be from 0 to 4, for example. Furthermore, as shown in FIG. 6B, the PSDCH has a structure based on the PUSCH, and it has a structure in which DM-RSs are inserted.

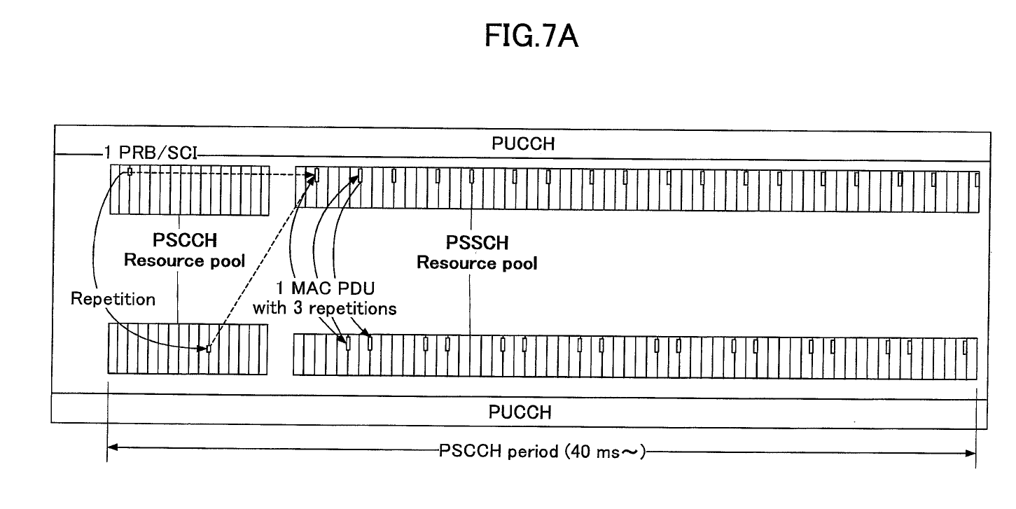

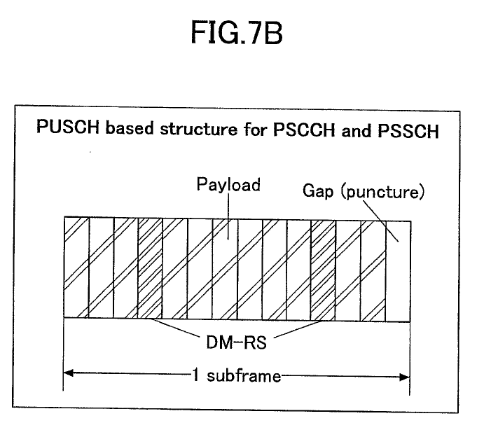

FIG. 7A shows examples of PSCCH and PSSCH resource pools used for “Communication.” As shown in FIG. 7A, the PSCCH is repeatedly transmitted (repetition) once while being frequency-hopped. The PSSCH is repeatedly transmitted (repetition) three times while being frequency-hopped. Furthermore, as shown in FIG. 7B, the PSCCH and the PSSCH respectively have structures based on the PUSCH, and they have structures in which DM-RSs are inserted.

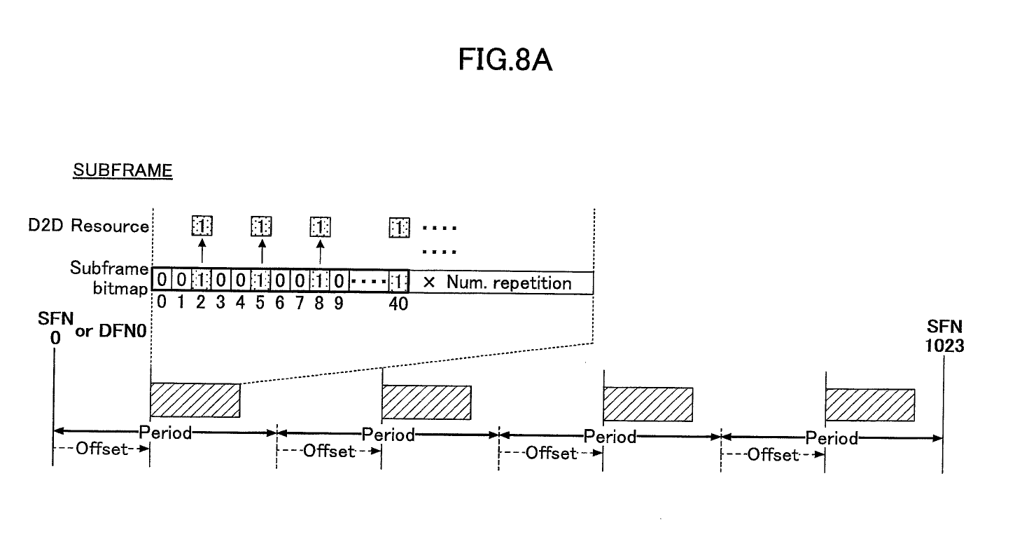

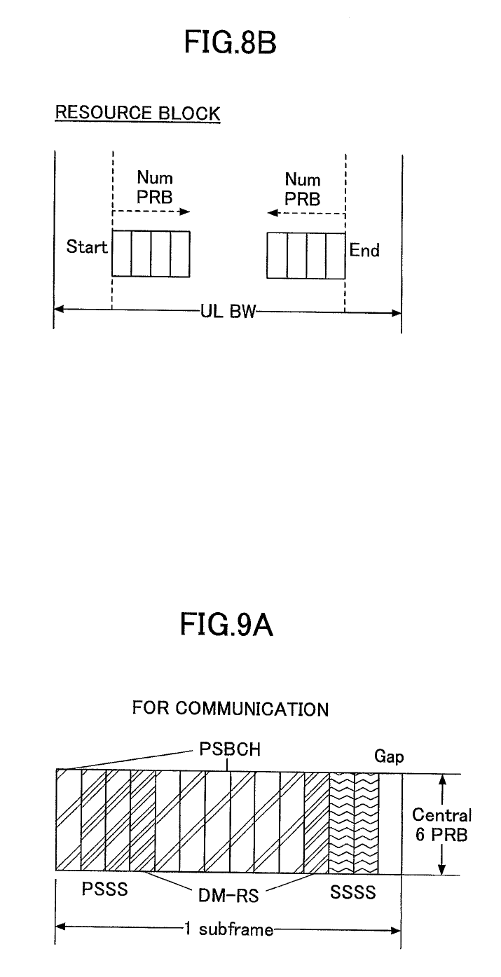

FIG. 8A shows an example of a resource pool configuration for each of the PSCCH, the PSDCH, and the PSSCH (Mode 2). As illustrated in FIG. 8A, in the time direction, the resource pool can be represented as a subframe bitmap. Furthermore, the bitmap is repeated the number of times of num.repetition. Furthermore, an offset is specified that indicates a start position in each period.

In the frequency direction, contiguous allocation (contiguous) and non-contiguous allocation (non-contiguous) are available. FIG. 8B shows an example of non-contiguous allocation; and, as depicted, the start PRB, the end PRB, and the numbers of PRBs (numPRB) are specified.

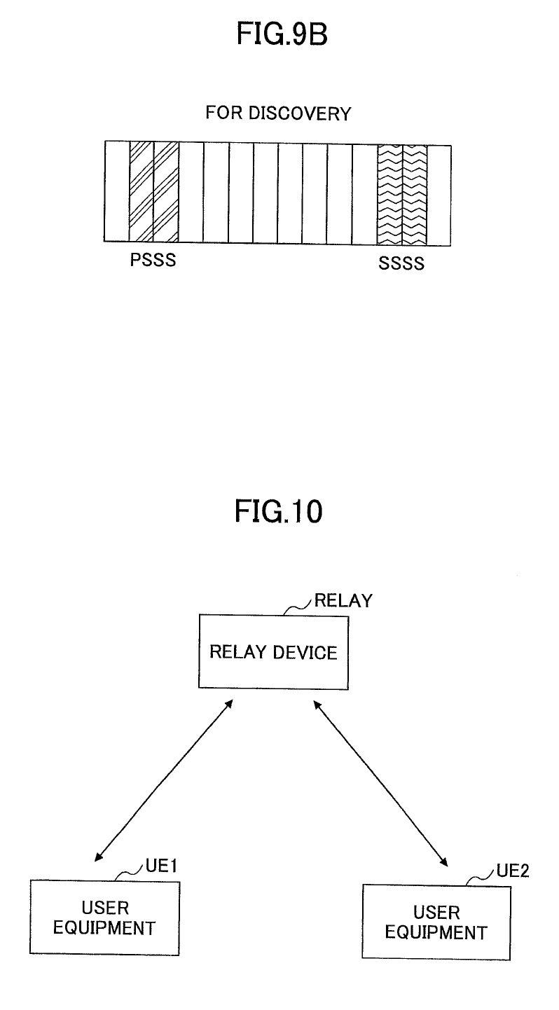

FIG. 9A and FIG. 9B show the PSSS/SSSS. FIG. 9A shows an example of a synchronization subframe in communication. As illustrated in the figure, the PSSS, the SSSS, the DM-RS, and the PSBCH are multiplexed. FIG. 9B shows an example of a synchronization subframe in discovery. As illustrated in the figure, the PSSS and the SSSS are multiplexed.

The PSBCH includes DFN (D2D frame number); a TDD UL-DL configuration; an In-coverage indicator; a system bandwidth; a reserved field, and so forth.

(System Configuration)

FIG. 10 shows a configuration example of the communication system according to the embodiment. As shown in FIG. 10, the relay device RELAY, the user equipment UE 1, and user equipment UE 2 are included in the communication system. As described above, in the following, the relay device RELAY is denoted as “RELAY,” the units of user equipment UE 1 and UE 2 are denoted as UE 1 and UE 2. Furthermore, when the UE 1 and the UE 2 are not particularly distinguished, they are simply described as UEs. Furthermore, in the example illustrated in FIG. 10, one RELAY is shown, and two UEs are shown; however, this is merely an example, and there may be multiple RELAYs and the number of the UEs may be greater than or equal to three.

The RELAY in the embodiment is, for example, a road-side unit (RSU: Road Side Unit) installed at a road side; however, it is not limited to this. The RELAY may be, for example, a UE that function as a relay device; or an eNB that functions as a relay device.

Each of the UE 1 and UE 2 illustrated in FIG. 10 is provided with a function for cellular communication, as a UE in LTE; and a D2D function including a function for signal transmission and reception on the above-described channels. Furthermore, similar to the UE, the RELAY may be provided with a function for cellular communication, as a UE in LTE; and a D2D function including a function for signal transmission and reception on the above-described channels.

### Outline of the Embodiments

In the following, an embodiment 1 and an embodiment 2 are described, which are for a specific operation of the communication system provided with the above-described configuration. First, outlines of the embodiment 1 and the embodiment 2 are described. In each of the cases of the embodiment 1 and the embodiment 2, the RELAY is provided with a function for simultaneously transmitting and receiving signals on a plurality of carriers.

Note that, in the description, the terms “message” and “data” are used; however, in general, “message” implies information transmitted by a UE that is the transmission source; and “data” includes “message,” and it implies a packet, etc., at a layer that is lower than that of “message.” However, the case where “message is received” may also be “data is received,” so that, in the description, “message” may be “data,” and “data” may be “message.” Furthermore, “carrier” may be reworded as “channel,” “frequency,” “band,” and so forth.

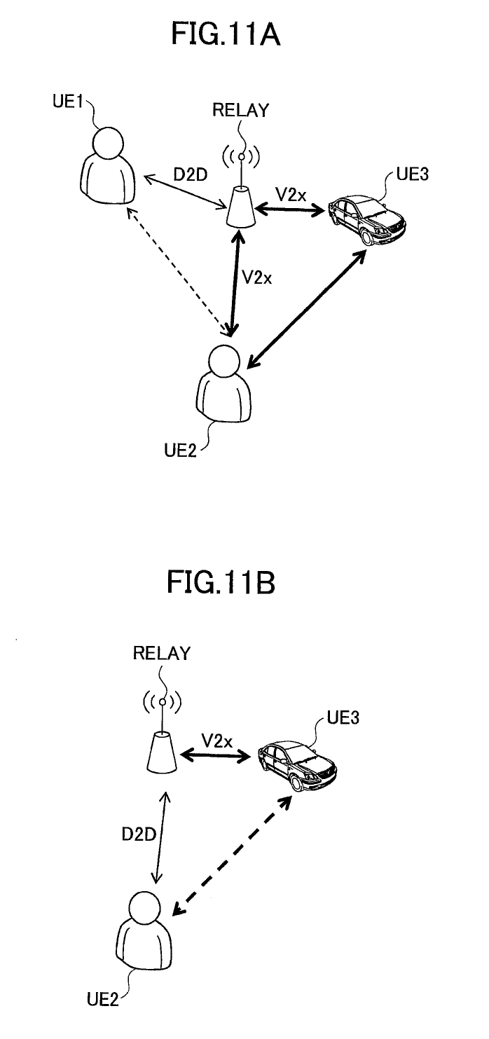

In the embodiment 1, a RELAY receives a message transmitted by a UE on a specific carrier by broadcasting; and transmits the message on a carrier that is different from the specific carrier. For example, as illustrated in FIGS. 11A and 11B, the RELAY receives the message on a D2D channel; and transmits the message on a V2X channel. Furthermore, the RELAY can receive a message on a V2X channel, and can transmit the message on the D2D channel.

Furthermore, the RELAY may transmit (broadcast) assist information for assisting the UE to switch the carrier. The assist information is, for example a V2X resource pool configuration transmitted on a D2D channel; a D2D resource pool configuration transmitted on a V2X channel, and so forth.

For example, in the example of FIG. 11A, by receiving assist information regarding D2D from the RELAY, the UE 2 using the V2X channel can switch to the D2D channel. Furthermore, in the example of FIG. 11B, by receiving assist information regarding the V2X from the RELAY, the UE 2 using the D2D channel can switch to the V2X channel.

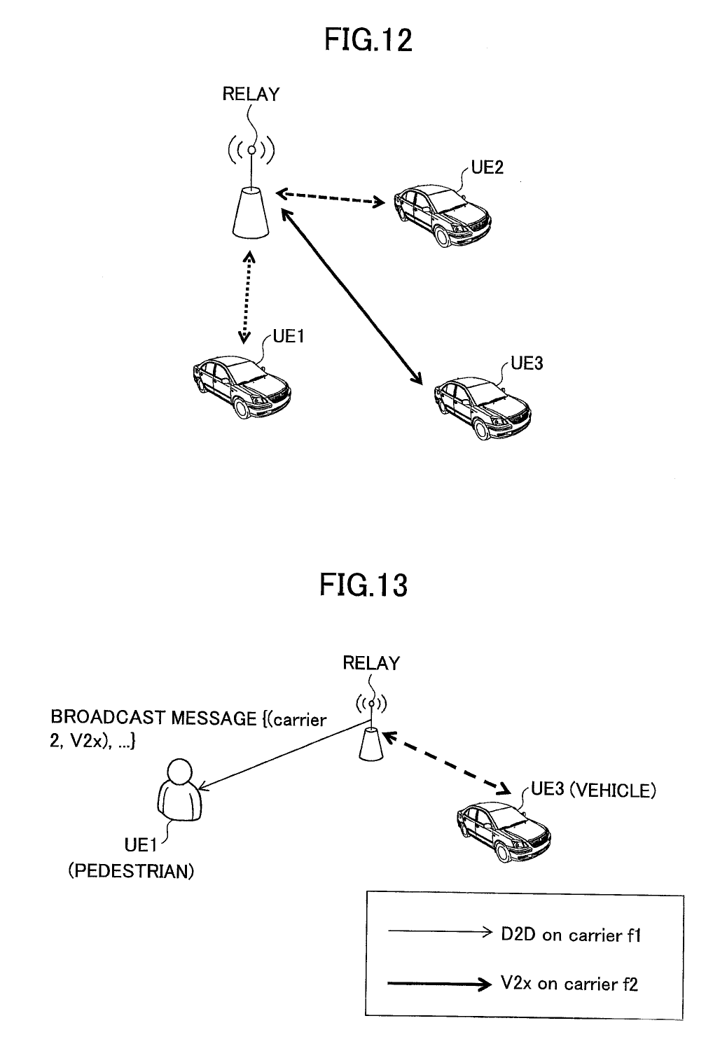

In the embodiment 2, the RELAY relays communication among UEs on different carriers. For example, in the example of FIG. 12, the UE 1, the UE 2, and the UE 3 are respectively using different carriers. At this time, for example, the RELAY receives a message transmitted from the UE 1 on the carrier A; and transmits the message to the UE 2 on the carrier B. Furthermore, in the embodiment 2, by receiving assist information from the RELAY, each UE can also switch a carrier, so that communication is performed on the carrier that is the same as that of another UE.

In the following, the embodiment 1 and the embodiment 2 are more specifically described.

### Embodiment 1

First, an operation example 1-1 through an operation example 1-3 are described as basic operation examples in the embodiment 1.

### Operation Example 1-1

FIG. 13 is a diagram for illustrating the operation example 1-1, which is one of the operation examples in the embodiment 1. FIG. 13 illustrates the example where a pedestrian carries the UE 1; and the UE 3 is a vehicle (e.g., an automobile).

The RELAY transmits, on a specific carrier, a list of carriers at the side of transmitting a message to be relayed by broadcasting. In the example of FIG. 13, the RELAY transmits a message with a list including identification information of a V2X carrier f2 to be used by the UE 3 by broadcasting, in which a D2D carrier f1 is used. Note that, it is an example to use the broadcast; and multicast, group cast, or unicast may be used. Furthermore, a plurality of carriers may be included in the list.

The UE 1 that receives the above-described message can find a message transmitted on the carrier f2 can be received while using the carrier f1. In this manner, when it is necessary to receive a message transmitted (broadcast) on the carrier f2 (e.g., receiving an emergency message), the UE 1 can determine that it is not necessary to switch to the carrier f2. As illustrated in FIG. 13, the type of the carrier (e.g., V2X) may be included in the list of the carriers. Consequently, the UE 1 can determine whether the message on the carrier f2 relayed by the RELAY is to be received, depending on the type.

As a channel for transmitting the carrier list, for example, the PSDCH can be used; however, it is not limited to this.

### Operation Example 1-2

A threshold value, which is to be used for determining to switch a carrier by the UE at the side of receiving a message, may be included in the message to be transmitted by the RELAY. The threshold value may be preconfigured in each UE. Furthermore, the RELAY may transmit the threshold value with a message that is different from the message with which the carrier list is transmitted.

The UE provided with the threshold value measures received power (e.g., RSRP) of the broadcast message received from the RELAY; and, if the received power is higher than the threshold value, determines that it is not necessary to switch the carrier. The received power can be measured, for example, by using the DM-RS (e.g., FIG. 6B).

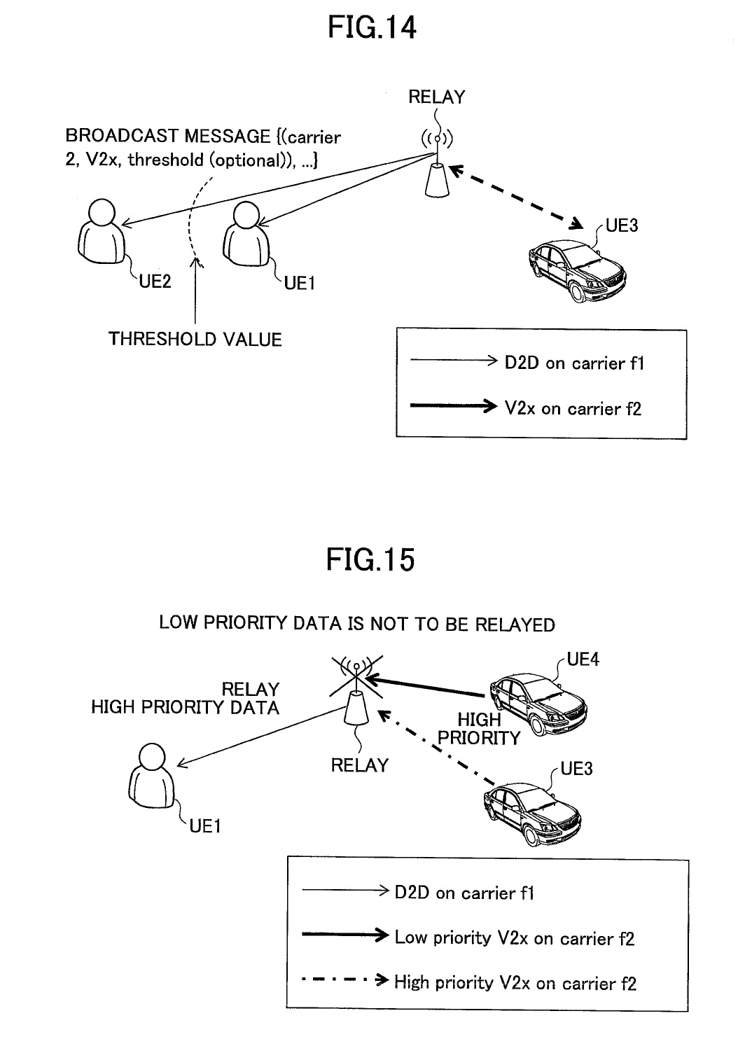

In the example of FIG. 14, the UE 1 and the UE 2 receive the threshold value from the RELAY. Since it is determined that the received power of the broadcast message is lower than or equal to the threshold value, the UE 2 determines that it is necessary to switch the carrier to receive the message transmitted on the carrier f2. However, since it is determined that the received power of the broadcast message is higher than the threshold value, the UE 1 determines that it is not necessary to switch the carrier to receive the message transmitted on the carrier f2.

### Operation Example 1-3

When the RELAY transmits all messages received on the carriers included in the carrier list on a different carrier (for convenience, which is referred to as a carrier A), the resources of the carrier A may be congested.

In order to avoid this congestion, in the operation example 1-3, the RELAY implements filtering of messages. As an example, the RELAY relays the message only if a priority class (priority class) of the received message is greater than a predetermined threshold value. The threshold value may be fixedly configured in the RELAY; or may be configured by the eNB, etc. Furthermore, for each carrier, the RELAY may include the threshold value in the broadcast message to transmit it. Consequently, the receiving UE can determine, for each carrier, data with which priority class or more is to be relayed.

The priority class can be identified, for example, by a value of the priority class included in the data (packet). Furthermore, the priority class may be determined based on an address of the transmission source, etc. Furthermore, as the priority class, the existing priority class of LTE may be used; or a newly specified priority class may be used.

Furthermore, instead of using the priority class as described above, or in addition to using the priority class, filtering may be performed depending on a destination of the message. For example, the RELAY relays only if the destination of the message is a destination indicating “pedestrian” (V2P). Here, for example, identification information indicating “pedestrian” is included in a header of the data, such as the MAC PDU; and the RELAY determines whether the destination is “pedestrian” based on the identification information. Note that it is merely an example to set the filtering condition to “pedestrian.” Another transmission/reception ID, an address, etc., may be the filtering condition.

For example, in the example illustrated in FIG. 15, the data is transmitted from the UE 4 on the carrier f2; however, the RELAY detects that the priority class of the data is less than or equal to the threshold value, so that the data is not to be relayed. However, when the data is transmitted from the UE 3 on the carrier f2, the RELAY detects that the priority class of the data is greater than the threshold value, so that the data is relayed. Consequently, the UE 1 can receive the data transmitted from the UE 3 through the RELAY.

Note that, in the examples illustrated in FIG. 13 through FIG. 15, same types of messages received on the carrier f2 may be aggregated by the RELAY, so that the number of the messages to be transmitted on the carrier f1 can be reduced. Furthermore, the RELAY may convert the message received on the carrier f2 into a message with a format to be used on the carrier f1. The process of reducing the number of the messages and the process of converting the message format can be applied to both the embodiment 1 and the embodiment 2.

<Operation Example Related to Specifying an L2 Address, Etc.>

For each message relayed by the RELAY from the transmission source of the message, identification information of the carrier is to be added, on which the RELAY receives the message. Consequently, the UE that receives the message transmitted from the RELAY can find that the message is from which transmission source using which carrier. The identification information of the carrier may be included, for example, in a MAC subheader of the MAC PDU carrying the data including the message. However, this is an example.

Furthermore, a special L2 (layer 2) address (e.g., MAC address) may be introduced that identifies a group of UEs that receive a message relayed by the RELAY. Note that this L2 address may be referred to as a group cast L2 address. In this case, the RELAY adds the L2 address, as a destination address, to the message received on a certain carrier; and transmits the message (data) to which the L2 address is added on another carrier. The UE receiving the data retains the L2 address, as the address for receiving the relayed message; and, upon detecting the L2 address in the header of the received data, executes a process, such as decoding of the message that is the content (payload) of the data.

Note that, when the RELAY performs relaying from a plurality of carriers to a certain carrier (carrier A), the RELAY may use an address that is the same for all the plurality of carriers, as the group cast L2 address for the carrier A; or group cast L2 addresses that are different for respective carriers.

Note that, in the embodiment, the L2 address is used as the address; however, this is an example, and a configuration may be adopted in which a L1 address, a L3 address, and so forth are used, for example. Furthermore, an address, such as a L2 address, may be referred to as an ID.

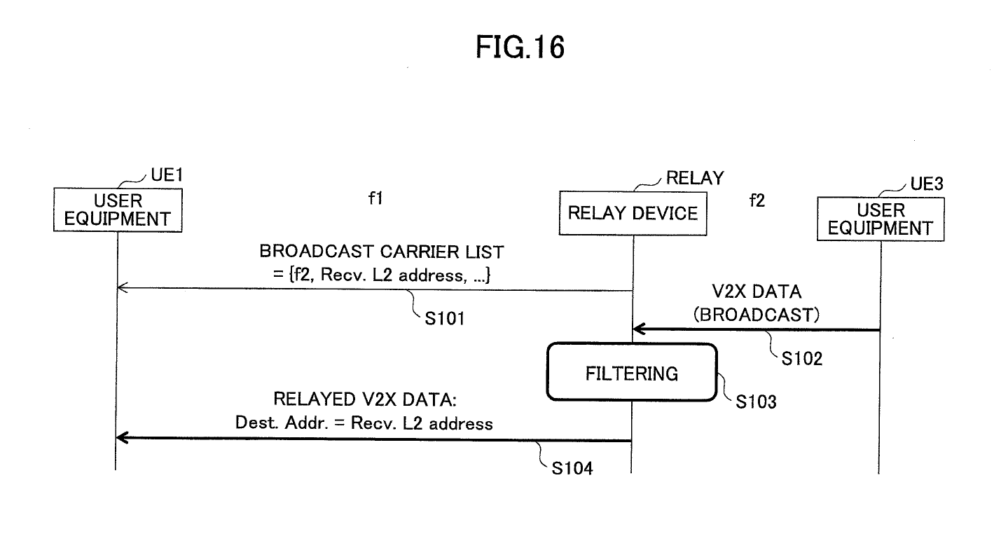

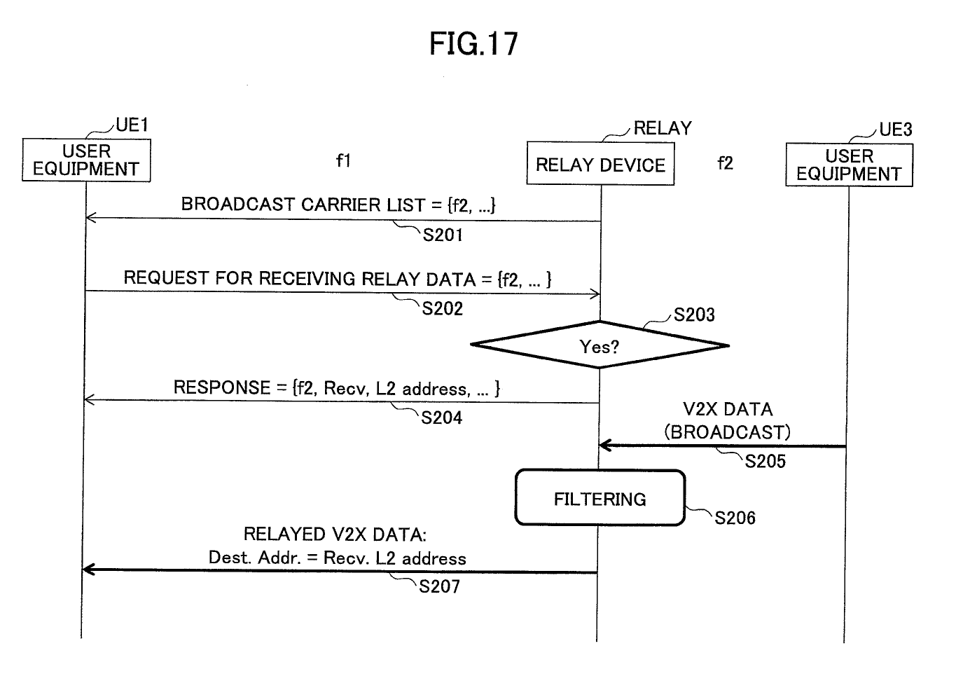

FIG. 16 and FIG. 17 show examples of the processing procedure for using the above-described L2 address (the group cast L2 address).

In the example shown in FIG. 16, first, at step S101, the RELAY transmits a message including a carrier list by broadcasting on the carrier f1. The message includes the carrier at the transmission side (f2 in the example of FIG. 16) that performs relaying, and the L2 address of the receiving side (destination) corresponding to the carrier.

The UE 1 that receives the message finds, based on the carrier list, that a message, in which the L2 address is configured as the destination address, is to be transmitted through the RELAY, as the relayed message from the transmission source on the carrier f2; and sets (retains) the L2 address as the L2 address of the receiving side, if reception of the message is desired.

After that, the UE 3 transmits data of a V2X message on the carrier f2 by broadcasting; and the RELAY receives the message. The RELAY performs the above-described filtering (step S103); and, upon determining to perform relaying the message, the RELAY adds, as the destination address, the L2 address, which is included in the carrier list reported at step S101, to the message, and transmits it (step S104). In response to detecting that the received message includes, as the destination address, the L2 address received at the step S101, the UE 1 performs decoding of the content of the message, etc.

In the example shown in FIG. 17, first, at step S201, the RELAY transmits, on the carrier f1, a message including a carrier list by broadcasting. The message includes the carrier of the transmission side (f2 in the example of FIG. 17) that performs relaying; however, at this stage, the L2 address of the receiving side (destination) is not included.

At step S202, the UE 1 that receives the above-described message desires to receive relaying of the message from the carrier f2; and transmits, to the RELAY, a request message indicating that relaying of the message from the carrier f2 is desired (step S202). The request includes, for example, identification information of the carrier f2. The type of the channel for transmitting the message is not particularly limited; however, for example, the PSSCH or the PSCCH may be used.

The RELAY that receives the request message determines whether to accept the request from the UE 1, for example, depending on a degree of congestion (step S203). Here, the RELAY accepts the request; and returns a response message to the UE 1 (step S204). The response message includes the L2 address of the receiving side (destination) corresponding to the carrier f2 to be relayed. After that, at steps S205, S206, and S207, the processes are performed, which are the same as those of steps S102, S103, and S104 in FIG. 16.

<Operation Example Related to the Transmission Source Address>

In the embodiment 1, the address of the transmission source (original source address) in the message transmitted from the transmission source may be reported to the receiving UE by a message relayed by the RELAY.

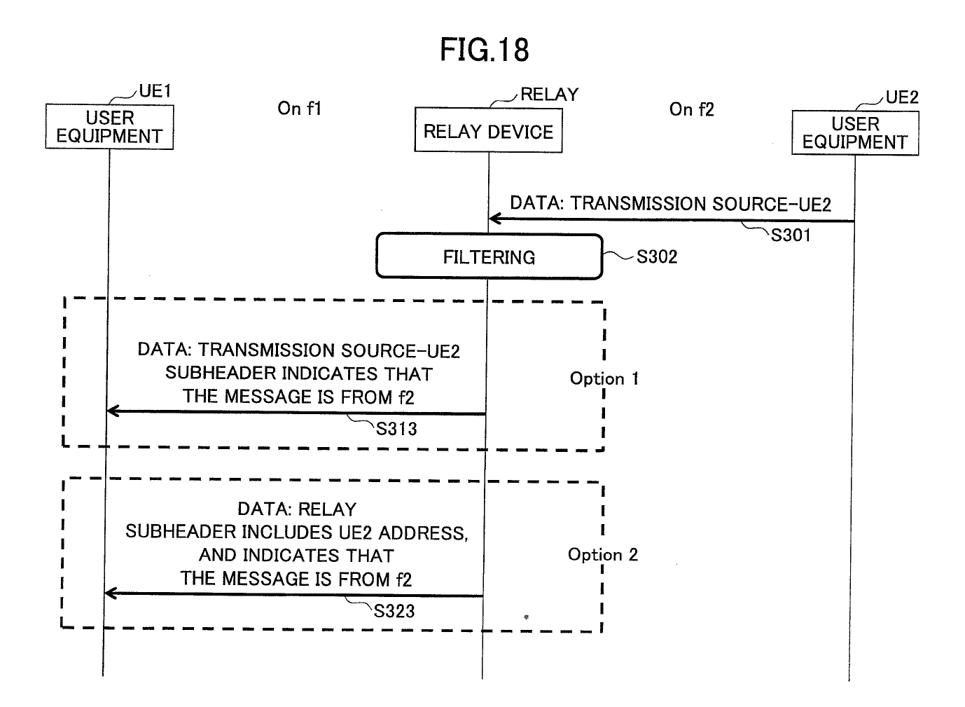

The operation example of this case is described by referring to FIG. 18. First, a message with the address of the UE 2 (e.g., L2 address), as the transmission source address, is transmitted from the UE 2 (step S301). At step S302, the RELAY performs filtering, and determines to relay the message.

There are option 1 and option 2 for the subsequent process. In option 1 (step S313), the RELAY uses, as the transmission source address of the data (packet), the transmission source address of the data received from the UE 2, without changing the source address. Furthermore, as described above, the MAC subheader and so forth include information indicating that the message to be relayed is the message related to relaying from the carrier f2.

In option 2 (step S323), the L2 address of the RELAY is set as the destination address of the data to be transmitted by relaying. Then, in addition to the information indicating that the relayed message is the message related to relaying from the carrier f2, the address of the transmission source (the L2 address of the UE 2) is included in the MAC subheader.

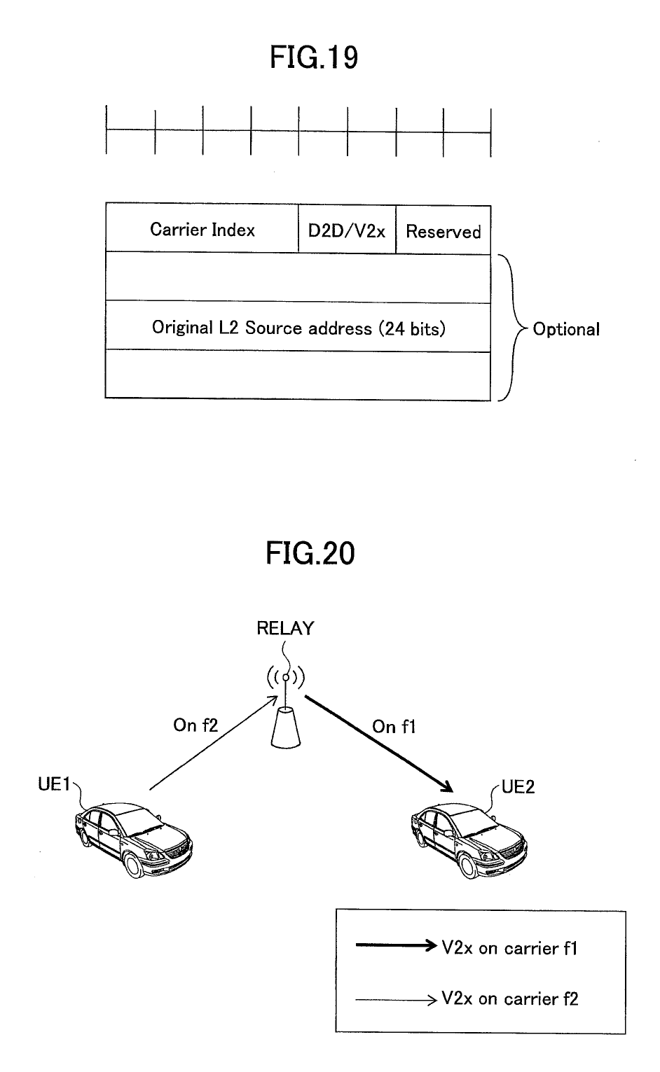

FIG. 19 shows an example of the MAC subheader to be used for setting the above-described information in the data to be relayed. As illustrated in FIG. 19, “Carrier Index” is included, which indicates the carrier to be used at the transmission side of the message to be relayed. Furthermore, as an option, the L2 address of the original transmission source is included. Furthermore, “D2D/V2X” is information indicating the type of the message to be relayed. In this field, the type of the carrier (e.g., D2D) of the original transmission source may be added, or the type of the transmission destination (the destination to which the message is to be relayed) may be added (e.g., the above-described “pedestrian,” etc.).

### Embodiment 2

Next, the embodiment 2 is described. In the embodiment 2, a situation is assumed such that the transmitting UE desires to transmit a unicast/group cast message to the receiving UE, and relaying in line with such a request is to be implemented.

For example, as shown in FIG. 20, when the UE 1 using the carrier f2 desires to transmit a message to the UE 2 using the carrier f1, the RELAY receives a message transmitted from the UE 1 using the carrier f2, and transmits the message to the UE 2 using the carrier f1.

In the following, the above-described operation is described in more detail using an operation example 2-1 and an operation example 2-2. In the following description, similar to the example of FIG. 20, the UE 1 is the transmitting side, and the UE 2 is the receiving side.

### Operation Example 2-1

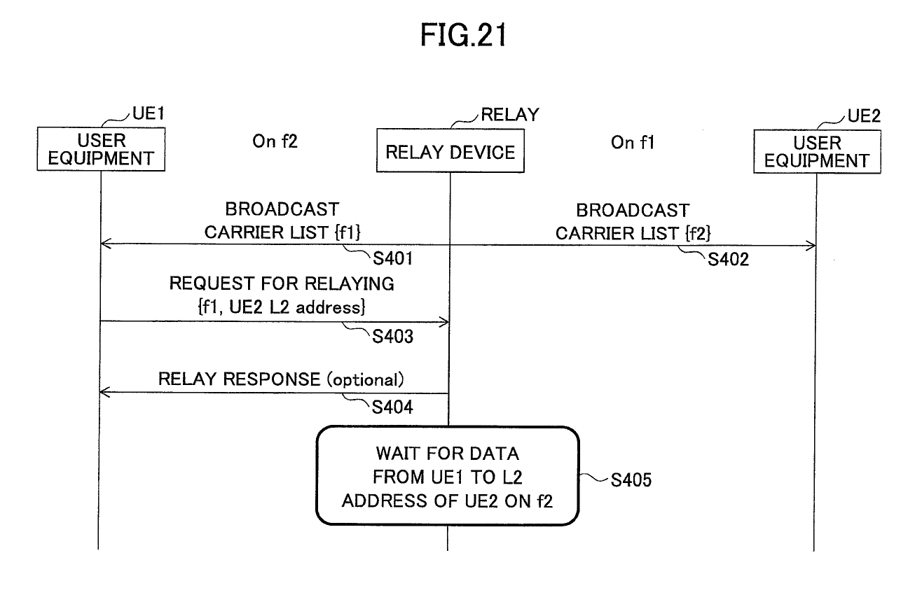

As the operation example 2-1, an example is described, in which relaying is to be performed based on a request of the transmitting UE (UE 1), by referring to FIG. 21.

First, the RELAY transmits a carrier list that is a list of the carriers with which relaying can be performed by broadcasting (step S401, S402). For example, f1, which is included in the carrier list transmitted on the carrier f2, indicates that the RELAY can perform relaying between f1 and f2. The same applies to f2, which is included in the carrier list transmitted on the carrier f1.

By step S401, the UE 1 finds that the RELAY can perform relaying between f1 and f2. Then, UE 1 transmits, to the RELAY, a request message for requesting relay of the message to the UE 2 on the carrier f1. The message includes a list of carriers to be relayed (only f1 is shown in the example of FIG. 21), and the L2 address of the destination (the L2 address of the UE 2 in the example of FIG. 21).

Note that the request message may not include the L2 address of the destination. In this case, the RELAY transfers all the messages received from the transmission source (the UE 1) to the destinations of the messages.

The RELAY that receives the request message at step S403 stores information included in the request message in a storage unit, such as a memory. For example, in the example of FIG. 21, the RELAY stores, in the storage unit, all of or a part of the address of the UE 1 (e.g., the L2 address), the identification information of the carrier f2, the address of the UE 2, and the identification information of the carrier f1. This information indicates that the message addressed to the UE 2 received from the UE 1 on the carrier f2 is to be transmitted to the UE 2 on the carrier f1.

After completing the above-described setting, the RELAY returns a response indicating that the setting for the UE 1 is completed (step S404). Note that this response may not be returned.

At step S405, the RELAY waits on the carrier f2 for the message addressed to the UE 2 with the UE 1 as the transmission source on the carrier f2; and, upon receiving the message, transfers the message to the UE 2. More specifically, upon receiving the message on the carrier f2, the RELAY compares information related to the message (f2, transmission source, destination) with the information stored in the storage unit (the information related to the request); and, upon detecting that it matches the information related to the request, transmits the message on the corresponding carrier.

### Operation Example 2-2

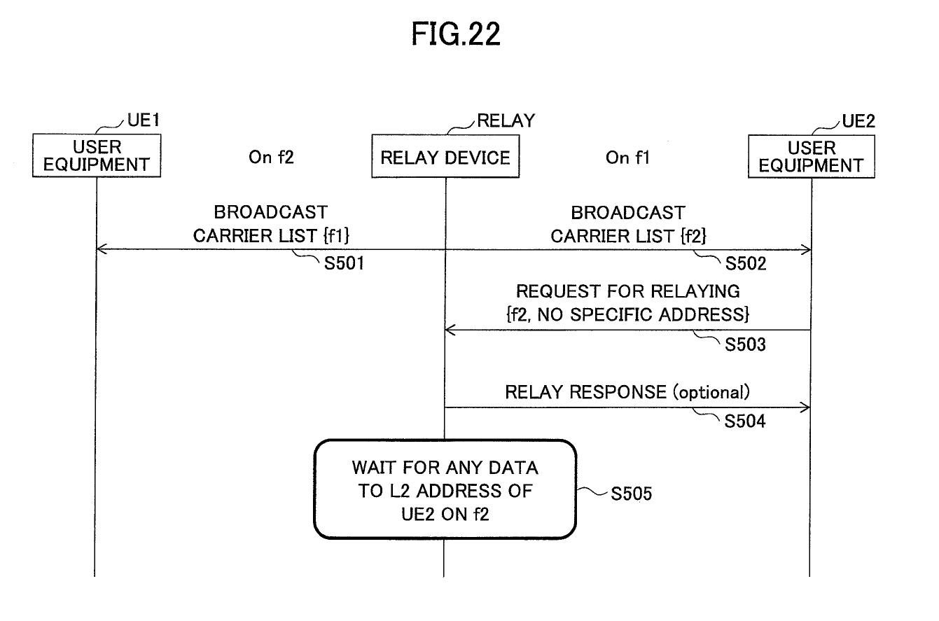

As the operation example 2-2, an example is described, in which relaying is to be performed based on a request of the receiving UE (UE 2), by referring to FIG. 22.

Similar to the operation example 2-1, the RELAY transmits the carrier list, which is the list of the carriers with which relaying can be performed, by broadcasting (steps S501 and S502).

By step S502, the UE 2 finds that the RELAY can perform relaying between f1 and f2. Then, the UE 2 transmits, to the RELAY, a request message for requesting to transmit (relay) the message transmitted on the carrier f2 to the UE 2 (step S503). The message includes a list of the carriers to be relayed (only f2 is shown in the example of FIG. 22). In the example shown in FIG. 22, no specific address is designated as the address of the transmission source. In this case, relaying is requested for all the messages addressed to the UE 2 and transmitted on the carrier f2.

At step S503, the UE 2 may specify, in addition to the carrier f2 to be relayed, an address of a specific transmission source. In this case, only messages transmitted from the specific transmission source are to be relayed.

The RELAY that receives the request message at step S503 stores information included in the request message in the storage unit, such as a memory. For example, in the example of FIG. 22, the RELAY stores, in the storage unit, the identification information of the carrier f2, the address of the UE 2, and the identification information of the carrier f1. The information indicates that the message received on the carrier f2 addressed to the UE 2 is to be transmitted to the UE 2 on the carrier f1.

After completing the above-described setting, the RELAY returns, to the UE 2, a response indicating that the setting is completed (step S504). Note that the response may not be returned.

At step S505, the RELAY waits on the carrier f2 for the message addressed to the UE 2; and, upon receiving the message, transfers the message to the UE 2. More specifically, upon receiving the message on the carrier f2, the RELAY compares information related to the message (f2, transmission source, destination) with the information stored in the storage unit (the information related to the request); and, upon detecting that it matches the information related to the request, transmits the message on the corresponding carrier.

<Example of the Relay Operation>

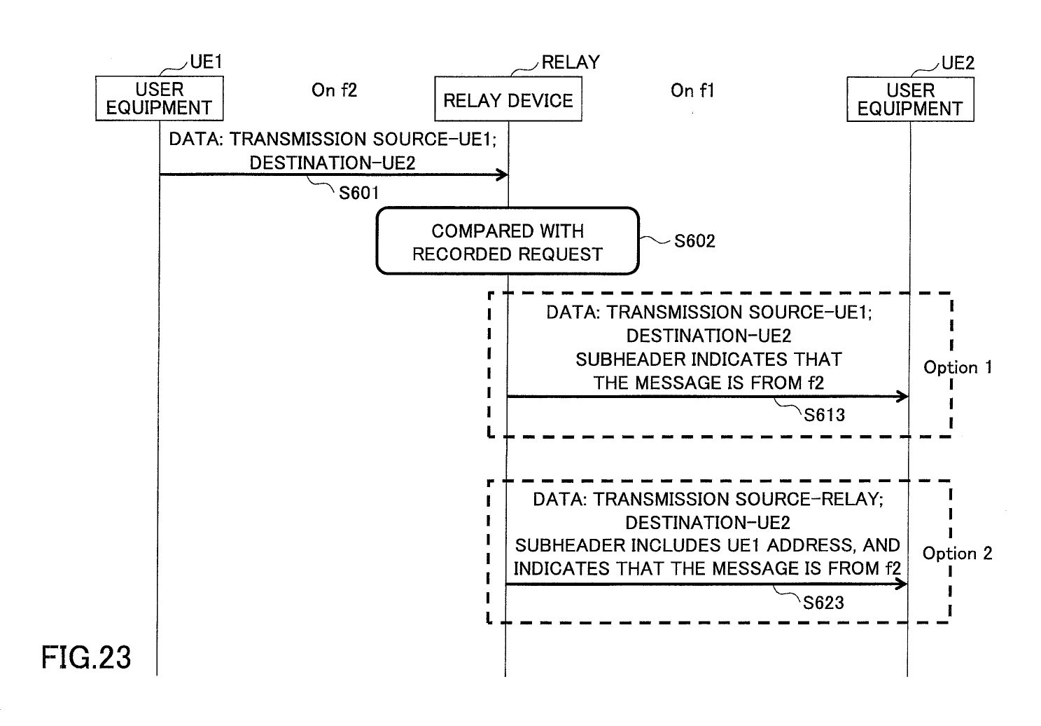

An example of the relay operation after the requesting process is described by referring to FIG. 23.

The UE 1 transmits data including a message (e.g., MAC PDU) to the RELAY (step S601). In the data, the L2 address of the UE 1 is set as the address of the transmission source, and the L2 address of the UE 2 is set as the destination address.

The RELAY that receives the data on the carrier f2 compares the carrier f2, the transmission source address, the destination address, and so forth of the data with the stored information; and upon detecting that they match, transmits the data to the UE 2 using the carrier of the matched information (the carrier f1 in the example of FIG. 23).

As shown in FIG. 23, there are option 1 and the option 2 for the setting of the transmission source address in the data at the time of transmission. In option 1 (step S613), the RELAY uses, as the transmission source address and the destination address of the data (packet), the transmission source address and the destination address of the data received from the UE 1 without changing them. The MAC subheader and so forth include information indicating that the message to be relayed is the message related to relaying from the carrier f2.

In option 2 (step S623), the L2 address of the UE 2 is set as the destination address of the data; however, the L2 address of the RELAY is set as the transmission source address. Then, in addition to the information indicating that the message to be relayed is the message related to relaying from the carrier f2, the address of the transmission source (the L2 address of the UE 1) is included in the MAC subheader.

A MAC subheader similar to that shown in FIG. 19 may also be used for the data related to relaying. As shown in FIG. 19, in the second embodiment, “Carrier Index” is also included, which indicates the carrier to be used at the side of the transmission source of the message to be relayed (f2 in the example of FIG. 23). Furthermore, as an option, the L2 address of the original transmission source is included (the L2 address of the UE 1, in the example of FIG. 23).

### Modified Examples

In the embodiment 1, a plurality of RELAYs may receive a message transmitted from the same UE by broadcasting. However, when multiple RELAYs perform relaying for the same message, resources in each RELAY are unnecessarily consumed. Thus, techniques, in the embodiment 1, for limiting the number of the RELAYs for relaying the same message are described, as modified examples. In the following, modified examples 1 through 3 are described. Note that, in the following, an example is described where the modified examples 1 through 3 are mainly applied to the embodiment 1; however, the modified examples 1 through 3 can be applied not only to the embodiment 1, but also to the embodiment 2.

### Modified Example 1

In the modified example 1, each RELAY of a plurality of RELAYs executes control such that the degree of congestion of the RELAY is to be found by monitoring a carrier list transmitted by another RELAY by broadcasting; and, upon detecting that it is congested, it is autonomously switched to Inactive, and relaying is terminated.

More specifically, a specific RELAY (which is referred to as the RELAY 1, for convenience) receives (obtains) the carrier list transmitted from another RELAY on the carrier to be used by the RELAY 1 for relay transmission. Then, based on the obtained carrier list, the RELAY 1 counts, for each pair of two carriers with which the RELAY 1 can perform relaying (the carrier used for reception from the transmission source and the carrier used for transmission to the transmission destination), the number of other RELAYs (overlapped number) that can perform relaying with the same pair.

Then, if, for each pair, the number exceeds a threshold value, the RELAY 1 terminates relaying for the pair; and deletes the carriers of the pair from the carriers to be transmitted by broadcasting.

Note that, in order to avoid simultaneously terminating to perform relaying by the plurality of RELAYs, each RELAY may use a timer that clocks a random time length. For example, even if the number exceeds the threshold value, relaying with the pair is not terminated during the interval in which the timer does not expire; and, when the timer expires, relaying with the pair is terminated. The above-described threshold value may be fixedly set, or may be set by the eNB.

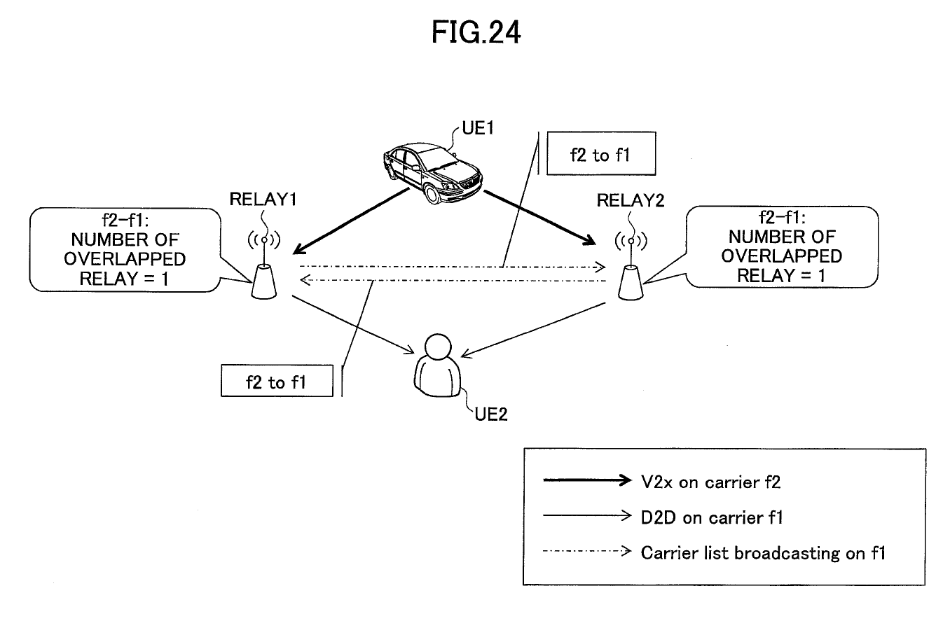

A more specific example is described by referring to FIG. 24. In the example of FIG. 24, the RELAY 1 and the RELAY 2 exist. Each RELAY can perform relaying from f2 to f1; and transmits, using f1, a carrier list by broadcasting.

Each RELAY finds that the overlapping number of the f2-f1 pair is 1 by receiving the carrier list of the other RELAY. Suppose that zero is set in the RELAY 1 as the threshold value. Then, the RELAY 1 is to perform an operation for terminating the operation with the f2-f1 pair.

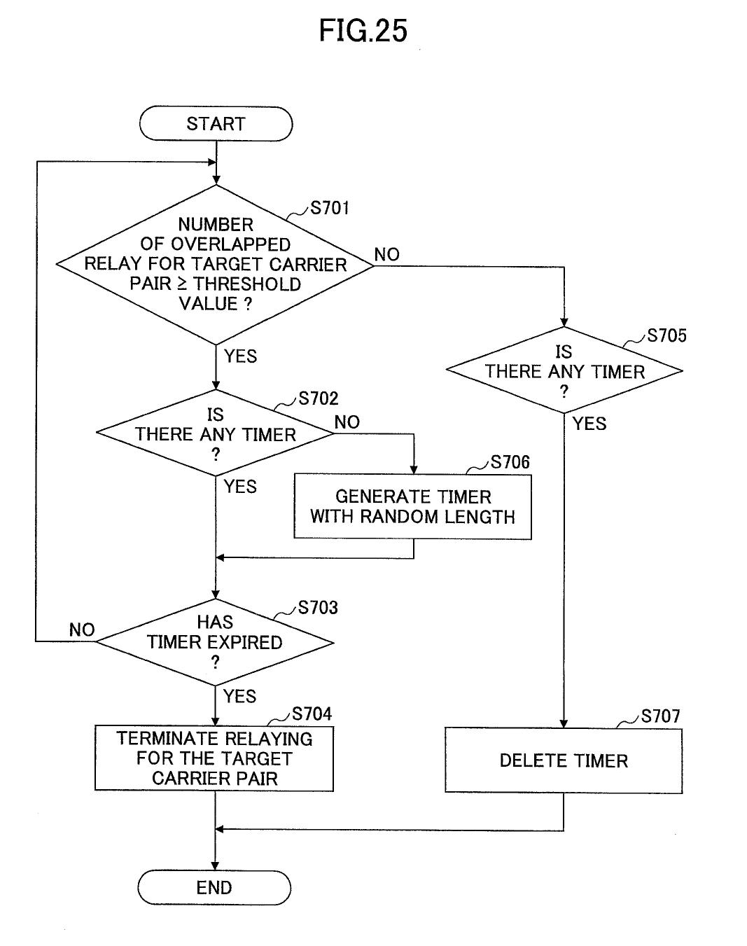

FIG. 25 is a flowchart showing a procedure of an operation to terminate relaying to be executed by each RELAY (which is supposed to be the RELAY 1 here, for convenience). Furthermore, FIG. 25 shows the procedure which focuses on a specific carrier pair.

At step S701, the RELAY 1 determines, for the target carrier pair, whether the overlapping number is greater than or equal to a threshold value (in this example, it is set to be “greater than or equal to the threshold value”). If the determination here is Yes, the process proceeds to step S702, and it is determined whether a timer is generated. If it is generated (Yes at step S702), the process proceeds to step S703; and if it is not generated (No at step S702), a timer is generated with a random time length at step S706, and the process proceeds to step S703. Here, to generate a timer corresponds to activate a timer with a desired time length. At step S703, a determination is made as to whether the timer has expired. If it has expired (Yes at step S703), relaying with the corresponding carrier pair is terminated at step S704. If the timer has not expired (No at step S703), the process returns to step S701.

If the determination at step S701 is No (when the overlapping number is less than the threshold value), the process proceeds to step S705. If there exists a timer, the timer is deleted (steps S705 and S707).

### Modified Example 2

Next, the modified example 2 is described. In the modified example 2, it is assumed that a determination is made on the termination of relaying based on control from the eNB to the RELAY.

For example, similar to the modified example 1, the RELAY finds, for each supported carrier pair, the overlapping number; and reports, for each carrier pair, the overlapping number to the eNB. Furthermore, statistics (e.g., an average) on the quality of the message to be relayed (reception quality, transmission quality, etc.) may be reported to the eNB. For example, if the overlapping number is greater than or equal to the threshold value, the eNB indicates to the RELAY that relaying with the carrier pair is to be terminated.

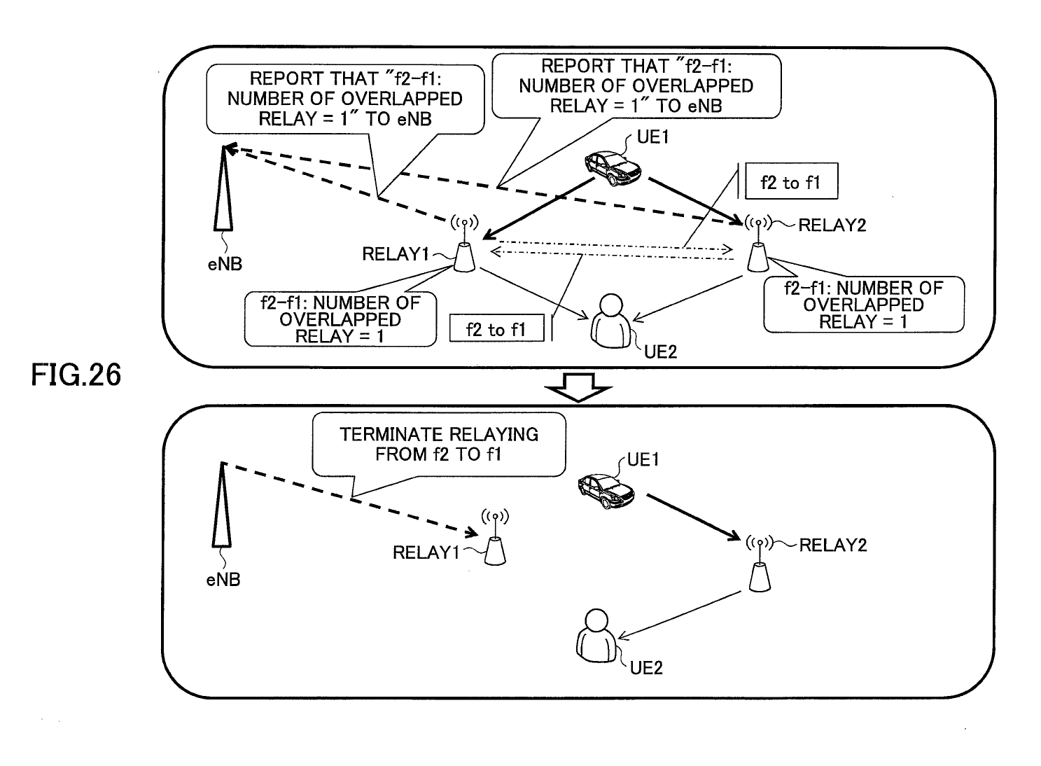

A specific example is described by referring to FIG. 26. Similar to the case of FIG. 24, in this example, the RELAY 1 and the RELAY 2 exist. Each RELAY reports, to the eNB, the overlapping number for the carrier pair f2-f1 (which is one in the example of FIG. 26).

For example, the eNB selects a number of the RELAYs (e.g., one for the RELAY 1), so that the overlapping number does not exceed the threshold value by causing to terminate relaying; and indicates, to the RELAY 1, to terminate relaying.

Consequently, as illustrated at the lower side of FIG. 26, only the RELAY 2 can be caused to perform relaying.

### Modified Example 3

Next, the modified example 3 is described. In the modified example 3, the UE that is the transmission source of the broadcast message selects a RELAY to perform relaying of the message, based on the received power and so forth from the RELAY.

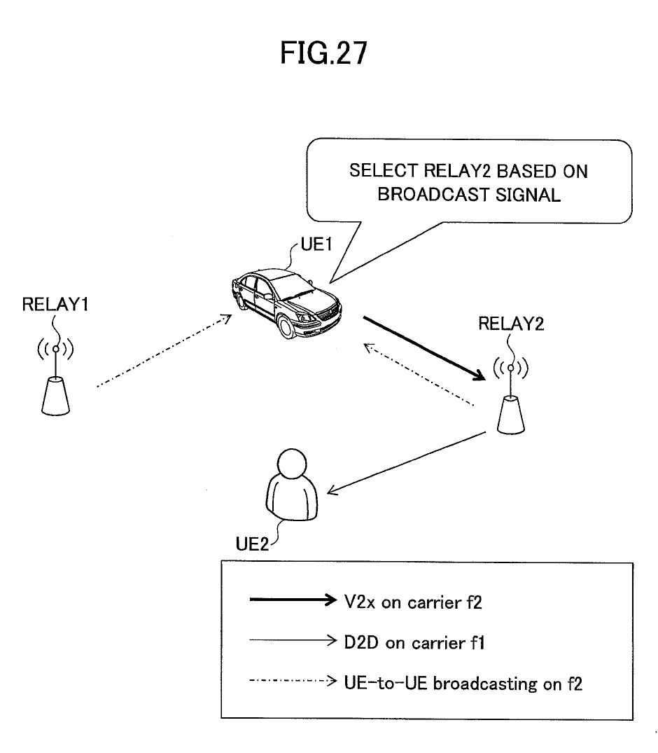

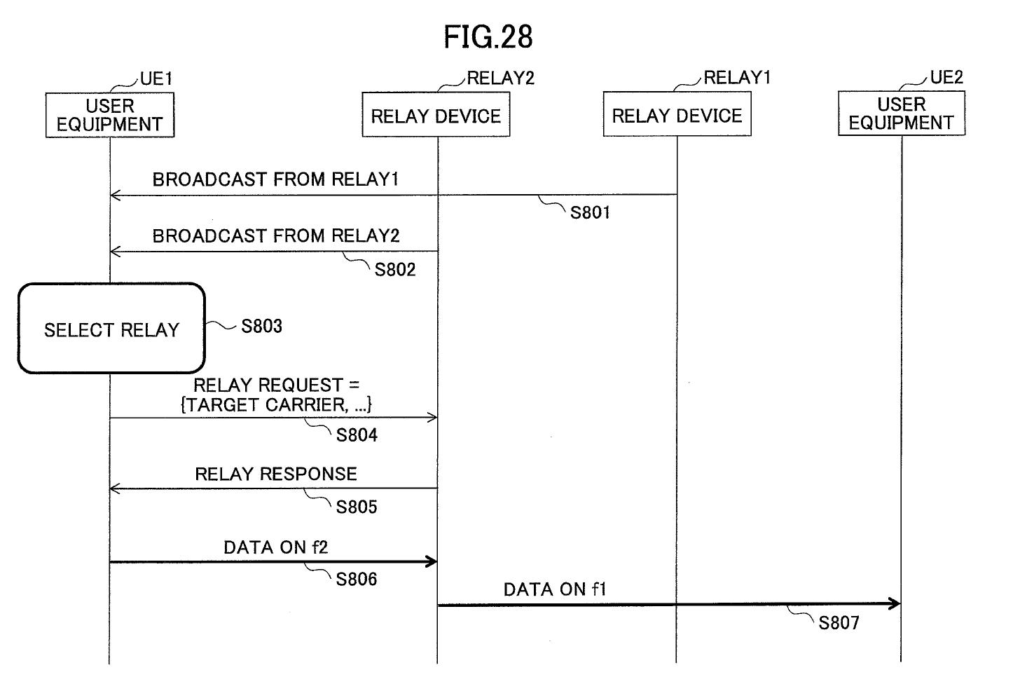

The specific example is described by referring to FIG. 27 and FIG. 28. In the example of FIG. 27, it is shown that the UE 1 selects, between the RELAY 1 and the RELAY 2, the RELAY 2 as the RELAY to perform relaying.

FIG. 28 shows the procedure. First, the UE 1 receives a broadcast message transmitted from each of the RELAY 1 and the RELAY 2 (steps S801 and S802). At step S803, the UE 1 selects the RELAY 2 based on the received power of the signal of the message; and transmits a relay request to the RELAY (step S804). Then, the UE 1 receives a relay response from the RELAY 2 (step S805); and starts transmitting the data of the message (steps S806 and S807).

(Restriction of the Relay Hop Number)

In the embodiments 1 and 2 described above, the relay is one hop; however, relaying by multiple hops via a plurality of RELAYs is also possible. However, in order to avoid occurrence of a loop of data relaying and so forth, it is necessary to provide a limit on the number of hops.

Thus, in the embodiment, a hop counter field is provided in the header of the data (specifically, the MAC subheader), and a hop count is incremented each time the data reaches the RELAY (or transmitted from the RELAY). Then, when the value of the hop count becomes greater than or equal to a threshold value (the maximum hop number), the RELAY discards the message.

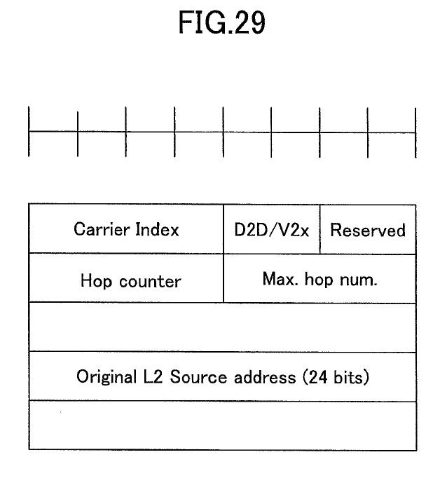

FIG. 29 shows an example of the MAC subheader. In the example shown in FIG. 29, in addition to the above-described “Carrier Index” and so forth, a hop counter (Hop counter) and the maximum hop number (Max.hop.num) are included.

(Example of Control by the eNB)

The RELAY in the embodiment can operate without being controlled by the eNB; however, as described below, it may be controlled by the eNB.

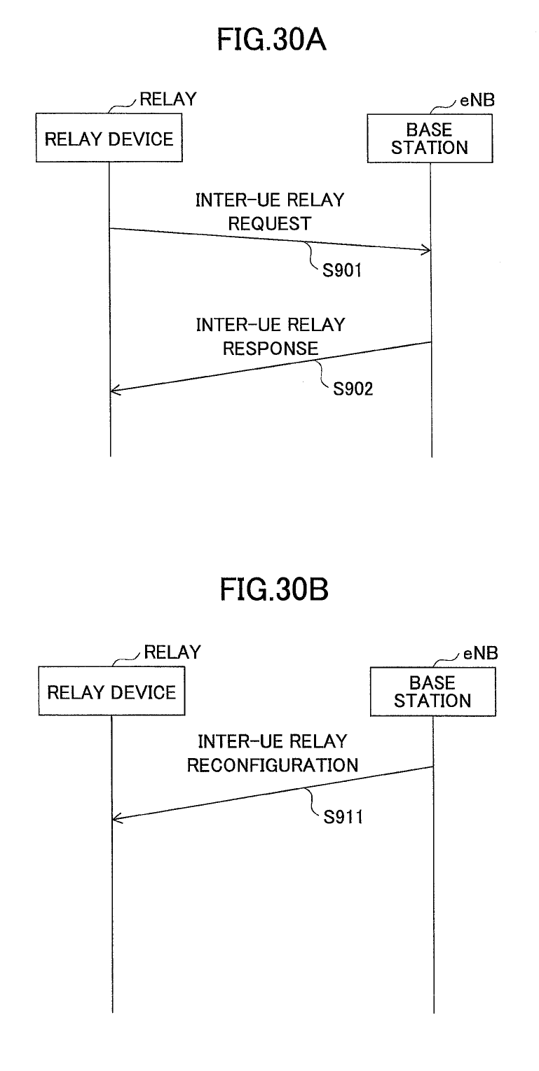

In this control example, as shown in FIG. 30A, first, the RELAY transmits an inter-UE (UE-to-UE) relay request to the eNB (step S901). This request is a request for obtaining permission for the RELAY (e.g., the RSU) to operate as a device for performing relaying between UEs. Based on this request, the eNB that permits the operation as a relay device transmits, to the RELAY, an inter-UE relay response for permitting to perform the inter-UE relay operation (step S902).

By using the inter-UE relay response described above, the eNB may report, to the RELAY, the configuration information, such as the content of the broadcast message (e.g, the content of the carrier list) and the radio parameters. In the following, the information reported from the eNB to the RELAY is referred to as the “configuration information.”

Furthermore, instead of the inter-UE relay response, or in addition to the inter-UE relay response, the configuration information may be reported by a message of an inter-UE relay reconfiguration (UE-to-UE relay reconfiguration), such as that shown in FIG. 30B.

Similar to the UE-specific information, the above-described configuration may be information specific (specific) to the RELAY; information that is common among the RELAYs (e.g., cell-specific information); or information that is common in the system.

Furthermore, as the specific configuration information, there are, for example, the above-described carrier list, the L2 address used by the RELAY to receive the message, the parameter used to filter the relayed message, the resource pool to be used for transmitting the message to be relayed, and so forth.

Furthermore, the radio parameters used for the inter-UE relaying in the RELAY may be controlled by the eNB. The radio parameters are transmitted from the eNB to the RELAY using a PHY signal, a MAC signal, a RRC signal, and so forth. Furthermore, the power control parameters may be reported from the eNB to the RELAY. However, the power control parameters may be different from the parameters used for normal UL power control.

(Resource Pool Used for Relaying)

In the embodiment, for example, a resource pool such as that shown in FIG. 8 can be used, as a resource pool for transmitting and receiving, by the UE, messages related to relaying.

Furthermore, for the UE that receives a relayed message, a dedicated resource pool (specific resource pool) may be allocated. An example of this case is described below. By being allocated a specific resource pool, the UE that receives a relayed message can reduce the complexity related to monitoring relayed messages. The resource pool is to be configured in the RELAY by the eNB, for example, by the procedure shown in FIGS. 30 A and 30B.

The above-described resource pool and the carrier of the message transmission source may be associated with each other, and during the above-described setting, mapping information indicating the association may be reported from the eNB to the RELAY. The mapping information is, for example, information indicating that “the resource pool 1 corresponds to the carriers f1 and f2,” information indicating that “the resource pool 2 corresponds to the carrier f2,” and so forth.

The mapping information configured in the RELAY is reported to each UE through a broadcast message together with the carrier list (option 1). Alternatively, the mapping information may be reported through the relay response message (e.g., FIG. 17, FIG. 21, FIG. 22, etc.) (option 2). Alternatively, the mapping information may be directly reported to the UE by downlink signaling from the eNB (option 3).

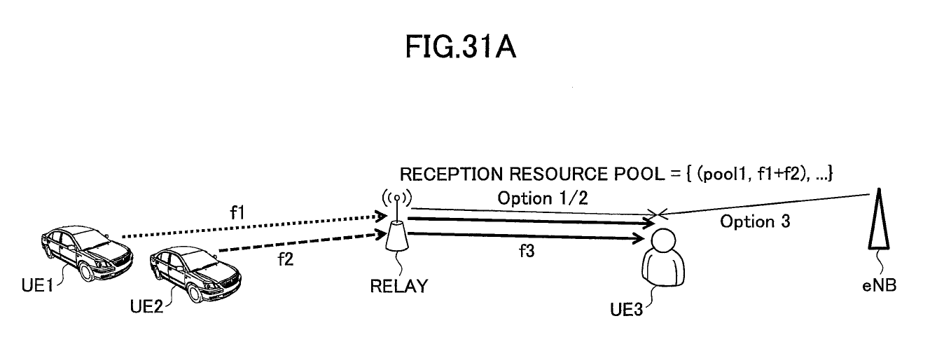

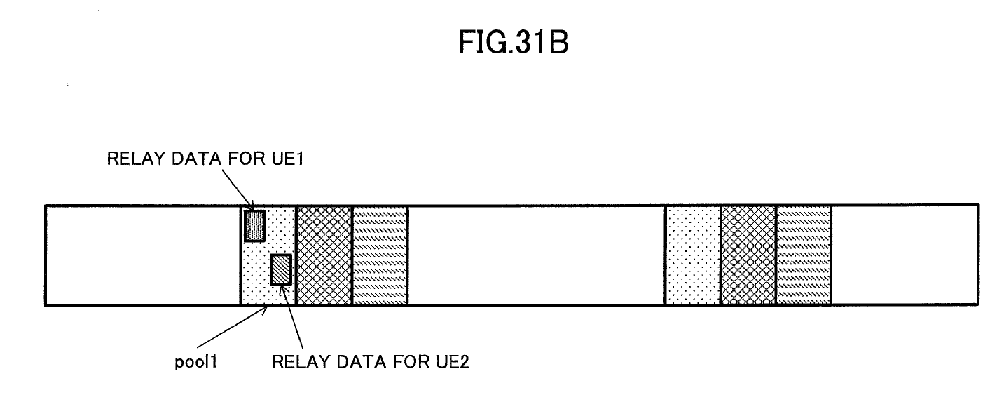

A specific example is shown in FIGS. 31A and 31B. As shown in FIG. 31A, here, a situation is shown such that the UE 1 and the UE 2, which are the UEs that are transmission sources of messages, transmit the messages using f1 and f2, respectively, and the RELAY transmits the messages to the UE 3 using f3.

Furthermore, a pool 1 is defined as a resource pool for receiving the messages from f1 and f2; and the RELAY transmits mapping information including the resource pool 1, f1, and f2 to the UE 3 on f3.

As shown in FIG. 31B, it suffices if the UE 3 that has received the mapping information monitors only the resources in the resource pool 1 for receiving the message from the UE 1 and the message from the UE 2, so that these messages can be efficiently received.

(Example of Applying Relay)

For example, when the RSU is used as the RELAY, a transmission resource for a message may be configured in the UE (e.g., vehicles in the vicinity) by the RSU, and the RSU may only relay all or a part of messages transmitted with the resource configured by the RSU, so that relaying is provided only to the vehicles in the vicinity.

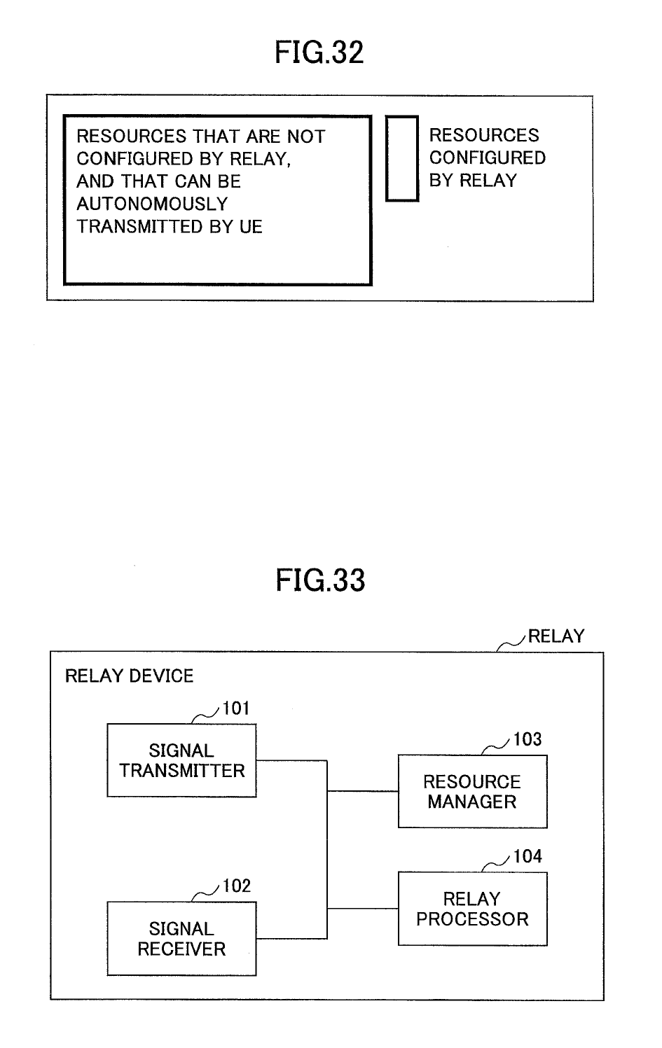

FIG. 32 shows an example of the resource to be configured in the UE (e.g., the vehicles in the vicinity). As shown in FIG. 32, a message that is transmitted with the resource configured by the RSU is relayed by the RSU, and is transmitted, for example, to a vehicle communicating on another carrier.

It is effective to establish such a resource configuration, for example, to prevent collisions at intersections. In this manner, by specifying, in advance, a resource that is a target of relaying, the transmitting UE can transmit a message to be relayed with a resource that is preferentially configured. Furthermore, when the RSU performs relay transmission, by performing transmission in a subframe other than the subframe of the configured resource, a probability of the detection error due to Half duplexing on the receiving side can be reduced.

Note that, in the above-described example, the case is described where the RSU is used as the RELAY; however, the above-described resource configuration may be established similarly in a RELAY other than the RSU.

(Device Configuration)

<Configuration Example of RELAY>

FIG. 33 shows a functional configuration diagram of the RELAY according to the embodiment. The RELAY illustrated in FIG. 33 may be any device that performs the relay operation described in the embodiment; however, for example, the RELAY is a device that is configured based on the UE or the eNB. The RELAY that is configured based on the UE is provided with, for example, a function for performing a relay operation, in addition to being provided with a function that is similar to that of the UE in LTE. Furthermore, the RELAY that is configured based on the eNB is provided with, for example, a function for performing a relay operation, in addition to being provided with a function that is similar to that of the eNB in LTE.

The RELAY shown in FIG. 33 can execute all the processes of the RELAY described above. However, only a part of the processes of the RELAY described above (e.g., only the first embodiment, or only the second embodiment, etc.) may be executable. In the following, main functions are described.

As shown in FIG. 33, the RELAY includes a signal transmitter 101; a signal receiver 102; a resource manager 103; and a relay processor 104. Note that FIG. 33 only shows, in the RELAY, functional units that are particularly related to the embodiment of the present invention. Furthermore, the functional configuration illustrated in FIG. 33 is merely an example. The functional division and names of functional units may be any division and names, provided that the operation according to the embodiment can be executed.

The signal transmitter 101 includes a function for generating various types of physical layer signals from one or more higher layer signals to be transmitted from the RELAY, and for wirelessly transmitting them. Furthermore, the signal transmitter 101 includes a transmission function for D2D (including V2X); and a transmission function for the cellular communication.

The signal receiver 102 includes a function for wirelessly receiving various types of signals from another RELAY, any other UE, or another eNB, etc., and for retrieving a higher layer signal from a received physical layer signal. The signal receiver 102 includes a reception function for D2D (including V2X); and a reception function for the cellular communication.

Furthermore, the signal transmitter 101 and the signal receiver 102 support a plurality of carriers; and can simultaneously perform signal transmission and reception in a plurality of different carriers.

The resource manager 103 retains, based on a configuration from the eNB, for example, information about a resource pool, etc., to be used for data transmission and reception in the RELAY itself. The information about the resource pool is utilized for data transmission and reception by the signal transmitter 101 and the signal receiver 102. Furthermore, the resource manager 103 is provided with a function for performing a process related to a resource, such as those of illustrated in FIG. 31 and FIG. 32.

The relay processor 104 is provided with a function for performing overall processing related to relaying in the embodiments. For example, it includes a function for indicating execution of relaying, etc., by specifying a carrier pair to the signal transmitter 101/signal receiver 102. Furthermore, it includes a function for filtering, a function for setting a group cast address configuration, a function for making a relay determination based on a relay request, a function for performing a process of calculating the overlapping number, a function for making a determination as to whether relaying is to be performed based on a comparison between the overlapping number and the threshold value, and so forth.

<Configuration Example of UE>

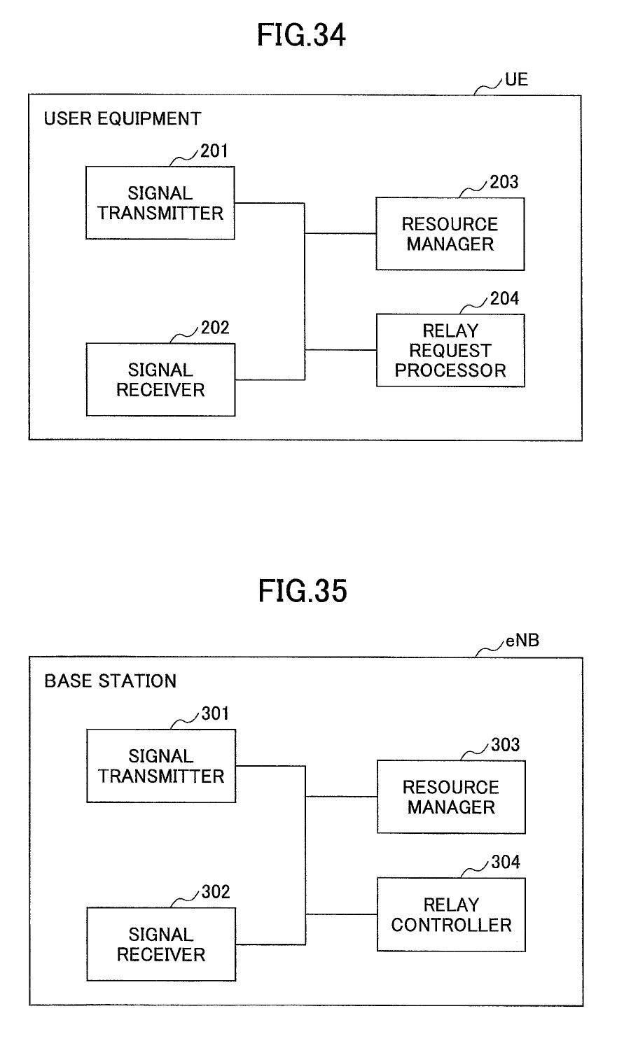

FIG. 34 shows a functional configuration diagram of the UE according to the embodiment. The UE shown in FIG. 34 is capable of executing all the processes of the UE described above. However, a part of the processes of the UE described above may be executable. In the following, main functions are described.

As shown in FIG. 34, the UE includes a signal transmitter 201; a signal receiver 202; a resource manager 203; and a relay request processor 204. Note that FIG. 34 only shows, in the UE, functional units that are particularly related to the embodiments of the present invention; and at least functions, which are not depicted, for performing operations conforming to LTE are also included. Furthermore, the functional configuration illustrated in FIG. 34 is merely an example. The functional division and names of functional units may be any division and names, provided that the operation according to the embodiment can be executed.

The signal transmitter 201 includes a function for generating various types of physical layer signals from one or more higher layer signals to be transmitted from the UE, and for wirelessly transmitting them. Furthermore, the signal transmitter 201 includes a transmission function for D2D (including V2X); and a transmission function for the cellular communication.

The signal receiver 202 includes a function for wirelessly receiving various types of signals from the RELAY, another UE, the eNB, etc., and for retrieving a higher layer signal from a received physical layer signal. The signal receiver 202 includes a reception function for D2D (including V2X); and a reception function for the cellular communication.

The resource manager 203 retains information about a resource pool, etc., to be used for data transmission and reception in the UE based on a configuration from the eNB or the RELAY, for example. The information about the resource pool is utilized for data transmission and reception by the signal transmitter 201/signal receiver 202. The relay request processor 204 executes, for example, the processes for the request/response, etc., in the UE, such as those illustrated in FIGS. 17, 21, and 22.

<Configuration Example of eNB>

FIG. 35 shows a functional configuration diagram of the eNB according to the embodiment. The eNB shown in FIG. 35 can execute all the processes of the eNB described above. In the following, main functions are described.

As shown in FIG. 35, the eNB includes a signal transmitter 301; a signal receiver 302; a resource manager 303; and a relay controller 204. Note that FIG. 35 only shows, in the eNB, functional units that are particularly related to the embodiment of the present invention; and at least functions, which are not depicted, for operating as an eNB in a mobile communication system conforming to LTE may also be included. Furthermore, the functional configuration illustrated in FIG. 35 is merely an example. The functional division and names of functional units may be any division and names, provided that the operation according to the embodiment can be executed.

The signal transmitter 301 includes a function for generating various types of physical layer signals from one or more higher layer signals to be transmitted from the eNB, and for wirelessly transmitting them. The signal receiver 302 includes a function for wirelessly receiving various types of signals from a UE, a RELAY, and so forth, and for retrieving a higher layer signal from a received physical layer signal.

The resource manager 303 includes a function for retaining resource information, such as that of a resource pool to be configured for the UE, the RELAY, etc., and for reporting the resource pool, etc., to the UE, the RELAY, etc. As described by referring to FIG. 26, the relay controller 304 performs control, etc., to terminate and indicate relaying in the RELAY. Furthermore, as described by referring to FIGS. 30A and 30B, it also includes a function to make various types of configurations for the UE and the RELAY.

<Hardware Configuration>

The block diagram (FIG. 33 through FIG. 35) used for describing the above-described embodiment shows blocks in units of functions. These functional blocks (components) are implemented by any combination of hardware and/or software. Namely, each functional block may be implemented by a single device that is physically and/or logically coupled; or may be implemented two or more devices by directly and/or indirectly (e.g., wired and/or wireless) connecting the two or more physically and/or logically separated devices.

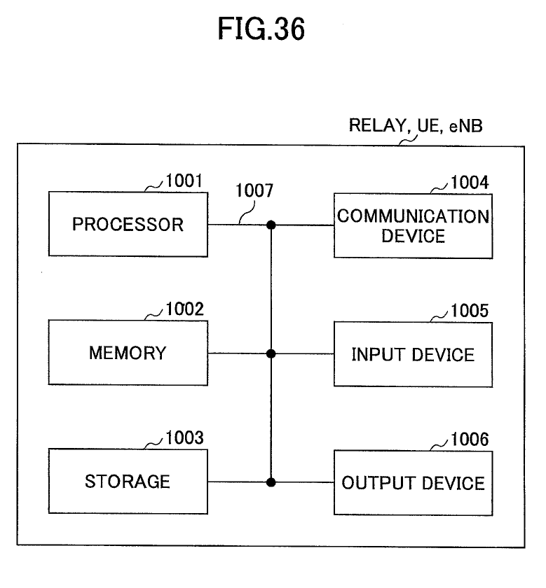

For example, the Relay, the eNB, and the UE according to the embodiment of the present invention may function as a computer for performing the process of the radio communication method according to the embodiment of the present invention. FIG. 36 is a diagram showing an example of a hardware configuration of each of the Relay, the eNB, and the UE according to the embodiment of the present invention. Each of the above-described Relay, the eNB, and the UE may be physically configured as a computer device including a processor 1001; a memory 1002; a storage 1003; a communication device 1004; an input device 1005; an output device 1006; a bus 1007, and so forth.

Note that, in the following description, the term “device” can be replaced with a circuit, an apparatus, a unit, and so forth. The hardware configuration of each of the Relay, the eNB, and the UE may be configured to include one or more devices that are depicted; or may be configured without including a part of the devices.

Each function in the Relay, the eNB, and the UE is implemented by loading predetermined software (program) on hardware, such as the processor 1001 and the memory 1002, so that the processor 1001 performs an operation to control communication by the communication device 1004, and reading and/or writing data in the memory 1002 and the storage 1003.

The processor 1001, for example, operates the operating system to control the entire computer. The processor 1001 may be formed of a central processing unit (CPU: Central Processing Unit) including an interface with a peripheral device, a control device, a processing device, a register, and so forth. For example, the signal transmitter 101, the signal receiver 102, the resource manager 103, and the relay processor 104 of the Relay may be implemented by the processor 1001. Furthermore, the signal transmitter 201, the signal receiver 202, the resource manager 203, and the relay request processor 204 of the UE may be implemented by the processor 1001. Furthermore, the signal transmitter 301, the signal receiver 302, the resource manager 203, and the relay controller 204 of the eNB may be implemented by the processor 1001.

Furthermore, the processor 1001 reads out a program (program code), a software module, or data from the storage 1003 and/or the communication device 1004 to the memory 1002; and executes various types of processes in accordance with these. As the program, a program is used, which is for causing a computer to execute at least a part of the operation described in the above-described embodiment. For example, the signal transmitter 101, signal receiver 102, the resource manager 103, and the relay processor 104 may be implemented by a control program that is stored in the memory 1002 and operated by the processor 1001; and the other functional blocks may be implemented similarly. Furthermore, the signal transmitter 201, signal receiver 202, the resource manager 203, and the relay request processor 204 of the UE may be implemented by a control program that is stored in the memory 1002 and operated by the processor 1001; and the other functional blocks may be implemented similarly. Furthermore, the signal transmitter 301, the signal receiver 302, the resource manager 303, and the relay controller 304 of the eNB may be implemented by a control program that is stored in the memory 1002 and operated by the processor 1001; and the other functional blocks may be implemented similarly. It is described that the above-described processes are executed by the single processor 1001; however, these may be executed simultaneously or sequentially by two or more processors 1001. The processor 1001 may be implemented by one or more chips. Note that the program may be transmitted from a network through an electric communication line.

The memory 1002 is a computer readable recording medium; and may be formed of, for example, at least one of a ROM (Read Only Memory), an EPROM (Erasable Programmable ROM), an EEPROM (Electrically Erasable Programmable ROM), a RAM (Random Access Memory), and so forth. The memory 1002 is capable of storing a program (program code), a software module, and so forth, which can be executed for implementing the communication method according to the embodiment of the present invention.

The storage 1003 is a computer readable recording medium; and may be formed of, for example, at least one of an optical disk such as a CD-ROM (Compact Disc ROM), a hard disk drive, a flexible disc, a magneto-optical disk (for example, a compact disk, a digital versatile disk, a Blu-ray (registered trademark) disk), a smart card, a flash memory (e.g., a card, a stick, a key drive), a Floppy (registered trademark) disk, a magnetic strip, and so forth. The storage 1003 may be referred to as an auxiliary storage device. The above-described storage medium may be, for example, a database including the memory 1002 and/or the storage 1003, a server, or another suitable medium.

The communication device 1004 is hardware (transmission/reception device) for performing communication between computers through a wired and/or wireless network; and, for example, it is also referred to as a network device, a network controller, a network card, a communication module, and so forth. For example, the signal transmitter 101 and the signal receiver 102 of the Relay may be implemented by the communication device 104. Furthermore, the signal transmitter 201 and the signal receiver 202 of the UE may be implemented by the communication device 1004. Furthermore, the signal transmitter 301 and the signal receiver 302 of the eNB may be implemented by the communication device 1004.

The input device 1005 is an input device (e.g., a keyboard, a mouse, a microphone, a switch, a button, a sensor, etc.) for receiving an input from outside. The output device 1006 is an output device (e.g., a display, a speaker, a LED lamp, etc.) that performs output to outside. Note that the input device 1005 and the output device 1006 may be integrated (e.g., a touch panel).

Furthermore, the devices, such as the processor 1001 and the memory 1002, are connected by the bus 1007 for communicating information. The bus 1007 may be formed of a single bus; or may be formed of buses that are different among the devices.

Furthermore, the Relay, the eNB, and the UE may be formed to include hardware, such as a microprocessor, a digital signal processor (DSP: Digital Signal Processor), an ASIC (Application Specific Integrated Circuit), a PDL (Programmable Logic Device), and a FPGA (Field Programmable Gate Array); and the hardware may partially or entirely implement each functional block. For example, the processor 1001 may be implemented by at least one of these hardware components.

### Conclusions of the Embodiments

As described above, according to the embodiments, there is provided a relay device of a mobile communication system supporting D2D, the relay device including a transmitter that transmits, on a second carrier, a broadcast message indicating that a relay process can be executed, the relay process being such that a message to be received on a first carrier is to be transmitted on the second carrier; and a relay unit that transmits, on the second carrier, the message received on the first carrier.

With the above-described configuration, transmission and reception of D2D signals can be properly executed among a plurality of carriers, in the mobile communication system supporting D2D.

The broadcast message may include a threshold value, and user equipment that receives the broadcast message may determine whether the message transmitted by the relay unit is to be received by comparing received power of the broadcast message and the threshold value. With this configuration, the user equipment can determine whether the message from the relay device is to be received or the carrier is to be switched.

The relay unit may transmit, among a plurality of messages received on the first carrier, only a message satisfying a predetermined condition on the second carrier. With such a configuration congestion on the second carrier can be avoided.

Furthermore, the same type of messages to be received on the first carrier may be aggregated in the relay device, so that the number of the messages to be transmitted on the second carrier can be reduced. For example, the same messages may be obtained by replacing user-specific information, such as a location and speed of a transmission source or transmission source user equipment, with a specific value; or information on a group of terminals, such as the number of detected terminals, coordinate ranges, or terminal types, etc., may be reported using a new message format. With this configuration, congestion on the second carrier can be avoided.

Furthermore, the message received on the first carrier may be converted into a message with a format used on the second carrier so as to be transmitted. For this reason, conversion and replacement of the message may be performed on a layer higher than the layer 2. A radio interface for the first carrier may be different from a radio interface for the second carrier, and various types of combinations can be considered, such as a combination of LTE and a next generation system of LTE, or a combination of LTE and WiFi. With this configuration, even if there is a difference in specifications of radio interfaces/messages between carriers, a message can be received.

The transmitter may transmit a reception address used for receiving the message to be transmitted on the second carrier at a side of the user equipment; and the relay unit may configure the reception address as a destination address of the message to be transmitted on the second carrier, and may transmit, on the second carrier, the message for which the reception address is configured. With this configuration, for example, a relay message can be transmitted only to user equipment for which a reception address is configured.

Furthermore, according to the embodiments, there is provided a relay device of a mobile communication system supporting D2D, the relay device including a transmitter that transmits, on a second carrier, a broadcast message indicating that a relay process can be executed, the relay process being such that a message to be received on a first carrier is to be transmitted on the second carrier; a receiver that receives a relay request for requesting to transmit, on the second carrier, the message to a specific destination by the relay process; and a relay unit that transmits, upon receiving, on the first carrier, the message specifying the specific destination, the message to the specific destination on the second carrier, based on the relay request.

With the above-described configuration, in the mobile communication system supporting D2D, transmission and reception of D2D signals can be properly performed among the plurality of carriers.

The relay unit may receive one or more broadcast messages to be transmitted from one or more other relay devices; may calculate, based on the one or more broadcast messages, a number of the other relay devices that are capable of performing a relay process from the first carrier to the second carrier; and may determine, based on the number, whether the relay process from the first carrier to the second carrier is to be performed. With this configuration, the number of the relay devices that perform the relay process with the same carrier pair can be limited, so that an effect, such as reduction of occurrence of waste of resources and reduction of the processing load on the relay device, can be obtained.

The transmitter may transmit, on the second carrier, information on a resource pool for reception on the second carrier and information on the first carrier associated with the resource pool. With this configuration, the user equipment that receives the above-described information can easily receive the message that is transmitted on the first carrier and that is relayed.

Furthermore, the “unit” in the configuration of the above-described device may be replaced with “part,” “circuit,” “device,” and so forth.

The RELAY described in the embodiment may have a configuration that is implemented by executing a program by a CPU (processor) in the device including the CPU and a memory; may have a configuration that is implemented by hardware provided with a logic for the process described in the embodiment, such as a hardware circuit; or may have a mixture of programs and hardware.

The UE described in the embodiment may have a configuration that is implemented by executing a program by a CPU (processor) in the UE including the CPU and a memory; may have a configuration that is implemented by hardware provided with a logic for the process described in the embodiment, such as a hardware circuit; or may have a mixture of programs and hardware.

The eNB described in the embodiment may have a configuration that is implemented by executing a program by a CPU (processor) in the eNB including the CPU and a memory; may have a configuration that is implemented by hardware provided with a logic for the process described in the embodiment, such as a hardware circuit; or may have a mixture of programs and hardware.

The embodiment of the present invention is described above; however the disclosed invention is not limited to the embodiment, and a person ordinarily skilled in the art will appreciate various variations, modifications, alternatives, replacements, and so forth. Specific examples of numerical values are used in the description in order to facilitate understanding of the invention. However, these numerical values are merely an example, and any other appropriate values may be used, except as indicated otherwise. The separations of the items in the above description are not essential to the present invention. Depending on necessity, subject matter described in two or more items may be combined and used, and subject matter described in an item may be applied to subject matter described in another item (provided that they do not contradict). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. For the convenience of description, the RELAY, the UE, and the eNB are described by using the functional block diagrams; however, such devices may be implemented in hardware, software, or combinations thereof. The software to be executed by the processor included in the RELAY, the UE, and the eNB in accordance with the embodiment of the present invention may be stored in any appropriate storage medium, such as a random access memory (RAM), a flash memory, a read-only memory (ROM), an EPROM, an EEPROM, a register, a hard disk drive (HDD), a removable disk, a CD-ROM, a database, a server, and so forth.

### Supplements to the Embodiment

Reporting of information is not limited to the aspects/embodiment described in this specification, and may be performed by another method. For example, reporting of information may be implemented by physical layer signaling (e.g., DCI (Downlink Control Information)), UCI (Uplink Control Information)), higher layer signaling (e.g., RRC signaling, MAC signaling, broadcast information (MIB (Master Information Block), SIB (System Information Block)), other signals or a combination thereof. Furthermore, the RRC message may be referred to as RRC signaling. Furthermore, the RRC message may be, for example, an RRC connection setup (RRC Connection Setup) message, an RRC connection reconfiguration (RRC Connection Reconfiguration) message, and so forth.

The aspects/embodiment described in the specification can be applied to LTE (Long Term Evolution); LTE-A (LTE-Advanced); SUPER 3G; IMT-Advanced; 4G; 5G; FRA (Future Radio Access); W-CDMA (registered trademark); GSM (registered trademark); CDMA 2000; UMB (Ultra Mobile Broadband); IEEE 802.11 (Wi-Fi); IEEE 802.16 (WiMAX); IEEE 802.20; UWB (Ultra-Wide Band); Bluetooth (registered trademark); a system that utilizes another suitable system and/or a next generation system evolved based on these.

The input/output information, etc., may be stored in a specific location (e.g., a memory), or may be managed by a management table. The input/output information, etc., may be overwritten, updated, or added. The output information, etc., may be deleted. The input information, etc. may be transmitted to another device.

The decision or determination may be performed by a value (0 or 1) represented by one bit; may be performed by a Boolean value (Boolean: true or false); or by numerical value comparison (e.g., a comparison with a predetermined value).

The information, signals, etc., described in the specification may be represented by using any of various different techniques. For example, the data, instruction, command, information, signal, bit, symbol, chip, etc., which may be referred to over the entire description above, may be represented by a voltage, an electric current, an electromagnetic wave, a magnetic field or magnetic particles, a light field or photons, or any combination thereof.

Note that the terms described in this specification and/or terms required for understanding the specification may be replaced with terms having the same or similar meanings. For example, a channel and/or a symbol may be a signal (signal). Furthermore, a signal may be a message.

The UE may be referred to, by a person skilled in the art, as a subscriber station; a mobile unit; a subscriber unit; a wireless unit; a remote unit; a mobile device; a wireless device; a wireless communication device; a remote device; a mobile subscriber station; an access terminal; a mobile terminal; a wireless terminal; a remote terminal; a handset; a user agent; a mobile client; a client; or some other suitable terms.

The order of the processing procedures, sequences, and so forth of the aspects/embodiment described in the specification may be re-arranged, provided that they do not contradict. For example, for the methods described in the specification, the elements of various steps are presented in an exemplary order, and are not limited to the specific order presented.

The each aspect/embodiment described in the specification may be used alone; may be used in combination; or may be used by switching depending on execution. Furthermore, reporting of predetermined information (e.g., reporting of “being X”) is not limited to the method of explicitly performing, and may be performed implicitly (e.g., not perform reporting of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The phrase “based on” used in this specification does not imply “based only on” unless explicitly stated otherwise. In other words, the phrase “based on” implies both “based only on” and “based at least on.”

The present invention is not limited to the above-described embodiment; and various variations, modifications, alternatives, replacements, and so forth are included in the present invention without departing from the spirit of the present invention.

This patent application is based upon and claims the benefit of priority of Japanese Patent Application No. 2015-160001 filed on Aug. 13, 2015, and the entire contents of Japanese Patent Application No. 2015-160001 are incorporated herein by reference.

### LIST OF REFERENCE SYMBOLS

RELAY: relay device
UE: user equipment
eNB: base station
101: signal transmitter
102: signal receiver
103: resource manager
104: relay processor
201: signal transmitter
202: signal receiver
203: resource manager
204: relay request processor
301: signal transmitter
302: signal receiver
303: resource manager
304: relay controller
1001: processor
1002: memory
1003: storage
1004: communication device
1005: input device
1006: output device

1. A relay device of a mobile communication system supporting Device to Device (D2D) communication, the relay device comprising:
a transmitter that transmits, on a second carrier, a broadcast message indicating that a relay process can be executed, the relay process being such that a message to be received on a first carrier is to be transmitted on the second carrier; and
a relay unit that transmits, on the second carrier, the message received on the first carrier.

2. The relay device according to claim 1, wherein the broadcast message includes a threshold value, and a user equipment that receives the broadcast message determines whether the message transmitted by the relay unit is to be received by comparing received power of the broadcast message and the threshold value.

3. The relay device according to claim 1, wherein the relay unit transmits, among a plurality of messages received on the first carrier, only a message satisfying a predetermined condition on the second carrier.

4. The relay device according to claim 1, wherein the transmitter transmits a reception address used for receiving the message to be transmitted on the second carrier at a side of user equipment, and
wherein the relay unit configures the reception address as a destination address of the message to be transmitted on the second carrier, and transmits, on the second carrier, the message for which the reception address is configured.

5. A relay device of a mobile communication system supporting Device to Device (D2D) communication, the relay device comprising:
a transmitter that transmits, on a second carrier, a broadcast message indicating that a relay process can be executed, the relay process being such that a message to be received on a first carrier is to be transmitted on the second carrier;
a receiver that receives a relay request for requesting to transmit, on the second carrier, the message to a specific destination by the relay process; and
a relay unit that transmits, upon receiving, on the first carrier, the message specifying the specific destination, the message to the specific destination on the second carrier, based on the relay request.

6. The relay device according to claim 1, wherein the relay unit receives one or more broadcast messages to be transmitted from one or more other relay devices;
calculates, based on the one or more broadcast messages, a number of the other relay devices that are capable of performing the relay process from the first carrier to the second carrier; and
determines, based on the number, whether the relay process from the first carrier to the second carrier is to be performed.

7. The relay device according to claim 1, wherein the transmitter transmits, on the second carrier, information on a resource pool for reception on the second carrier and information on the first carrier associated with the resource pool.

8. A relay method to be executed by a relay device of a mobile communication system supporting Device to Device (D2D) communication, the relay method comprising:
a transmission step of transmitting, on a second carrier, a broadcast message indicating that a relay process can be executed, the relay process being such that a message to be received on a first carrier is to be transmitted on the second carrier; and
a relay step of transmitting, on the second carrier, the message received on the first carrier.

9. A relay method to be executed by a relay device of a mobile communication system supporting Device to Device (D2D) communication, the relay method comprising:
a transmission step of transmitting, on a second carrier, a broadcast message indicating that a relay process can be executed, the relay process being such that a message to be received on a first carrier is to be transmitted on the second carrier;
a reception step of receiving a relay request for requesting to transmit, on the second carrier, the message to a specific destination by the relay process; and
a relay step of transmitting, upon receiving, on the first carrier, the message specifying the specific destination, the message to the specific destination on the second carrier, based on the relay request.

10. The relay device according to claim 2, wherein the relay unit transmits, among a plurality of messages received on the first carrier, only a message satisfying a predetermined condition on the second carrier.

11. The relay device according to claim 2, wherein the transmitter transmits a reception address used for receiving the message to be transmitted on the second carrier at a side of user equipment, and
wherein the relay unit configures the reception address as a destination address of the message to be transmitted on the second carrier, and transmits, on the second carrier, the message for which the reception address is configured.

12. The relay device according to claim 3, wherein the transmitter transmits a reception address used for receiving the message to be transmitted on the second carrier at a side of user equipment, and
wherein the relay unit configures the reception address as a destination address of the message to be transmitted on the second carrier, and transmits, on the second carrier, the message for which the reception address is configured.

13. The relay device according to claim 2, wherein the relay unit receives one or more broadcast messages to be transmitted from one or more other relay devices;
calculates, based on the one or more broadcast messages, a number of the other relay devices that are capable of performing the relay process from the first carrier to the second carrier; and
determines, based on the number, whether the relay process from the first carrier to the second carrier is to be performed.

14. The relay device according to claim 3, wherein the relay unit receives one or more broadcast messages to be transmitted from one or more other relay devices;
calculates, based on the one or more broadcast messages, a number of the other relay devices that are capable of performing the relay process from the first carrier to the second carrier; and
determines, based on the number, whether the relay process from the first carrier to the second carrier is to be performed.

15. The relay device according to claim 4, wherein the relay unit receives one or more broadcast messages to be transmitted from one or more other relay devices;
calculates, based on the one or more broadcast messages, a number of the other relay devices that are capable of performing the relay process from the first carrier to the second carrier; and
determines, based on the number, whether the relay process from the first carrier to the second carrier is to be performed.

16. The relay device according to claim 5, wherein the relay unit receives one or more broadcast messages to be transmitted from one or more other relay devices;
calculates, based on the one or more broadcast messages, a number of the other relay devices that are capable of performing the relay process from the first carrier to the second carrier; and
determines, based on the number, whether the relay process from the first carrier to the second carrier is to be performed.

17. The relay device according to claim 2, wherein the transmitter transmits, on the second carrier, information on a resource pool for reception on the second carrier and information on the first carrier associated with the resource pool.

18. The relay device according to claim 3, wherein the transmitter transmits, on the second carrier, information on a resource pool for reception on the second carrier and information on the first carrier associated with the resource pool.

19. The relay device according to claim 4, wherein the transmitter transmits, on the second carrier, information on a resource pool for reception on the second carrier and information on the first carrier associated with the resource pool.
